(19) United States
(12) Patent Application Publication
(10) Pub. No.: US 2019/0023254 A1
(43) Pub. Date: Jan. 24, 2019

(54) Railroad Control Valve with Modified Electronically Controlled Pneumatics (ECP) Mounting Face

(71) Applicant: Westinghouse Air Brake Technologies Corporation, Wilmerding, PA (US)

(72) Inventor: Jeffrey B. Skweres, McKeesport, PA (US)

(21) Appl. No.: 16/070,849

(22) PCT Filed: Jan. 13, 2017
(86) PCT No.: PCT/US2017/013356

§ 371 Date: Jul. 18, 2018

Related U.S. Application Data
(60) Provisional application No. 62/280,952, filed on Jan. 20, 2016.

(51) Int. Cl. B60T 17/22; B60T 13/66; B60T 15/02

(52) U.S. Cl. CPC B60T 17/228; B60T 15/027; B60T 13/665

(57) ABSTRACT

A service portion of a rail control valve having a charging check valve assembly that includes a body defining a piston passageway, an inshot valve passageway, and a service accelerated release valve passageway. The body includes a mounting flange having a mounting face having ECP porting. The service portion also includes an inshot valve received by the inshot valve passageway and a service accelerated release valve received by the service accelerated release valve passageway. The service portion further includes a cover plate mounted to at least a portion of the mounting face. A clearance is present between the cover plate and the charging check valve assembly.

### CROSS REFERENCE TO RELATED APPLICATIONS

This application claims priority to U.S. Provisional Application No. 62/280,952 filed on Jan. 20, 2016, the disclosure of which is hereby incorporated in its entirety by reference.

### BACKGROUND OF THE INVENTION

### Field of the Invention

The present invention relates to a brake apparatus for railway vehicles, and, more particularly, to a modified electronically controlled pneumatics (ECP) mounting face for a service portion of a brake control valve.

### Description of Related Art

China Railways have a standardized pneumatic air brake valve called “Type 120-1”, which is similar in overall operation to American Association of Railroads (AAR) pneumatic air brake valves (such as the WABCO ABD), with a pipe bracket, service portion, and emergency valve portion. Testing performed on the Type 120-1 valves reveal that during specific maintained brake pipe reductions, the Accelerated Application Valve function (AAV) can find a position in which it will ‘stick on’ and, thus, not be able to properly shut down. Therefore, the Type 120-1 service valve portion will continue to exhaust broke pipe presents locally at each freight car where this condition exists. When this occurs, this causes a further decrease in brake pipe pressure in the train and greatly increases the risks of undesired brake releases since the train's locomotive contains the pressure maintaining feature. Depending upon the number of service control valves that exhibit this undesirable function in a train, as increased risk of subjecting the train to an undesirable release condition exists. The AAV function helps to drive the brake pipe exhaust signal locally at each control valve, which therefore provides faster brake cylinder development during service brake applications. This function results in better overall train stopping ability and helps to stop longer and heavier freight trains in a more efficient manner The Chinese AK120 control valve does not have AAV functionality.

A main operating difference between the Type 120 and the ABD and related AAR valves is that the emergency portion provides only vent valve functions, and still relies on the service portion to move air from the reservoir to the brake cylinder. Further, there is no difference in brake cylinder equalization pressure between full service and emergency modes. The pipe bracket also differs with different mounting dimensions.

The Type 120 braking systems utilized in China are generally pneumatic. However, Electronically Controlled Pneumatics (ECP) braking systems are becoming more widely used and offer many advantages over pneumatic equipment. Having the ability to apply ECP equipment to railcars is generally desirable to take advantage of the superior braking and safety capabilities offered by ECP equipment.

Countries other than China use Chinese AK120 control valves, for instance, Australia and New Zealand. The Chinese AK120 control valves include a Chinese AK120 pipe bracket and include a Chinese AK120 charging check valve assembly.

United States Patent Publication Nos. 2013/0248031, 2015/0145323, and 2015/0144825, each incorporated herein by reference in their entireties, disclose features of a service portion of a rail control valve. Certain existing service portions, such as the ones disclosed in

US 2013/0248031, US 2015/0145323, and US 2015/0144825, are not, as designed, compatible with the Chinese AK120 control valves. For instance, certain existing service portions cannot be mounted to the Chinese AK120 pipe bracket due to clearance issues between a top of the service portion and the Chinese AK120 charging check valve assembly.

### SUMMARY OF THE INVENTION

The present invention is directed to a service portion of a rail control valve having a charging check valve assembly that includes a body defining a piston passageway, an inshot valve passageway, and a service accelerated release valve passageway. The body includes a mounting flange having a mounting face having ECP porting. The service portion also includes an inshot valve received by the inshot valve passageway and a service accelerated release valve received by the service accelerated release valve passageway. The service portion further includes a cover plate mounted to at least a portion of the mounting face. A clearance is present between the cover plate and the charging check valve assembly.

The present invention is also directed to a service portion of a rail control valve having a charging check valve assembly that includes a body defining a piston passageway, an inshot valve passageway, and a service accelerated release valve passageway. The body includes a mounting flange having a mounting face having ECP porting. The service portion also includes an inshot valve received by the inshot valve passageway and a service accelerated release valve received by the service accelerated release valve passageway. The ECP porting includes a plurality of ports in the mounting face and located adjacent to the charging check valve assembly. Access to the plurality of ports is unobstructed by the charging check valve assembly. The plurality of ports are configured to connect a brake cylinder exhaust core at the mounting face.

The present invention is also directed a method of making a service portion of a rail control valve having a charging check valve assembly. The method includes providing a service portion having a mounting flange having a mounting face having ECP porting. The method includes providing a plurality of ports into the mounting face to connect a brake cylinder exhaust core at the mounting face. The method includes mounting the service portion including the ECP porting to the rail control valve. Access to the plurality of ports is unobstructed by the charging check valve assembly.

From the foregoing disclosure and the following more detailed description, it will be apparent to those skilled in the art that the present invention provides a significant advance in the technology of a service portion of a brake control valve.

### BRIEF DESCRIPTION OF THE DRAWINGS

FIG. 1 is a front-top perspective view of an unmodified service portion body for a rail control valve;

FIG. 2 is a rear-bottom perspective view of the service portion body shown in FIG. 1;

FIG. 3 is a top view of the service portion body shown in FIG. 1;

FIG. 4 is a front view of the service portion body shown in FIG. 1;

FIG. 5 is a cross-sectional view of the service portion body shown in FIG. 1 along line A-A in FIG. 4;

FIG. 6 is a side view of the service portion body shown in FIG. 1;

FIG. 7 is a rear view of the service portion body shown in FIG. 1;

FIG. 8 is a bottom view of the service portion body shown in FIG. 1;

FIG. 9 is a cross-sectional view of the service portion body shown in FIG. 1 along line B-B in FIG. 8;

FIGS. 10-15 are various cross-sectional views of the service portion body shown in FIG. 1;

FIG. 16 is a cross-sectional view of the service portion body shown in FIG. 1 along line C-C in FIG. 3;

FIG. 17 is a cross-sectional view of the service portion body shown in FIG. 1 along line D-D in FIG. 3;

FIG. 18 is a perspective view of a grad valve;

FIG. 19 is a top view of the grad valve shown in FIG. 18;

FIG. 20 is a cross-sectional view of the grad valve shown in FIG. 18 along line E-E in FIG. 19;

FIG. 21 is a bottom view of the grad valve shown in FIG. 18;

FIG. 22 is a perspective view of a slide valve;

FIG. 23 is a schematic view of porting for a conventional ABDX slide valve;

FIG. 24 is a schematic view of porting for a conventional China 120-1 slide valve;

FIG. 25 is a schematic view of portion for the slide valve shown in FIG. 22;

FIG. 26 is a perspective view of a main bushing;

FIG. 27 is a schematic view of porting for a conventional ABDX bushing;

FIG. 28 is a schematic view of porting for a conventional China 120-1 bushing;

FIG. 29 is a schematic view of porting for the bushing shown in FIG. 26;

FIG. 30 is a perspective view of a service accelerated release (SAR) valve;

FIG. 31 is a top view of the SAR valve shown in FIG. 30;

FIG. 32 is an exploded perspective view of the SAR valve shown in FIG. 30;

FIG. 33 is a cross-sectional view of the SAR valve shown in FIG. 30 along line F-F in FIG. 31, showing the SAR valve in a closed position;

FIG. 34 is a cross-sectional view of the SAR valve shown in FIG. 30 along line F-F in FIG. 31, showing the SAR valve in an open position;

FIG. 35 is a perspective view of a SAR valve bushing;

FIG. 36 is a top view of the SAR valve bushing shown in FIG. 35;

FIG. 37 is a cross-sectional view of the SAR valve bushing shown in FIG. 35 along line G-G in FIG. 36;

FIG. 38 is a perspective view of a back-flow check valve;

FIG. 39 is a top view of the back-flow check valve shown in FIG. 38;

FIG. 40 is an exploded perspective view of the back-flow check valve shown in FIG. 38;

FIG. 41 is a cross-sectional view of the back-flow check valve shown in FIG. 38 along line H-H in FIG. 39, showing the back-flow check valve in a closed position;

FIG. 42 is a cross-sectional view of the back-flow check valve shown in FIG. 38 along line H-H in FIG. 39, showing the back-flow check valve in an open position;

FIG. 43 is a perspective view of an inshot valve;

FIG. 44 is an exploded perspective view of the inshot valve shown in FIG. 43;

FIG. 45 is a top view of the inshot valve shown in FIG. 43;

FIG. 46 is a cross-sectional view of the inshot valve shown in FIG. 43 along line I-I in FIG. 45, showing the inshot valve in a closed position;

FIG. 47 is a cross-sectional view of the inshot valve shown in FIG. 43 along line I-I in FIG. 45, showing the inshot valve in an open position;

FIG. 48 is a perspective view of an inshot valve bushing;

FIG. 49 is a top view of the inshot valve bushing shown in FIG. 48;

FIG. 50 is a cross-sectional view of the inshot valve bushing shown in FIG. 48 along line J-J in FIG. 49;

FIG. 51 is a cross-sectional view of a conventional China 120-1 accelerated release valve, showing a release and charging position;

FIG. 52 is a cross-sectional view of a conventional China 120-1 accelerated release valve, showing an accelerated release position;

FIG. 53 is a cross-sectional view of a conventional ABDX SAR valve;

FIG. 54 is cross-sectional view of the SAR valve shown in FIG. 30 and the back-flow check valve shown in FIG. 38, showing a closed position of the valves;

FIG. 55 is cross-sectional view of the SAR valve shown in FIG. 30 and the back-flow check valve shown in FIG. 38, showing an open position of the valves;

FIG. 56 is a cross-sectional view of a conventional China 120-1 emergency inshot valve, showing a release and charging position;

FIG. 57 is a cross-sectional view of a conventional China 120-1 emergency inshot valve, showing a service position;

FIG. 58 is a cross-sectional view of a conventional China 120-1 emergency inshot valve, showing an emergency position;

FIG. 59 is a cross-sectional view of a conventional ABDX emergency inshot valve;

FIG. 60 is a cross-sectional view of the inshot valve shown in FIG. 43, showing the valve in an open position;

FIG. 61 is a cross-sectional view of the inshot valve shown in FIG. 43, showing the valve in a closed position;

FIG. 62 is a front perspective view of the service portion body of FIG. 1;

FIG. 63 is a rear perspective view of the service portion body of FIG. 1;

FIG. 64 is a side view of the service portion body of FIG. 1;

FIG. 65 is a top view of the service portion body of FIG. 1;

FIG. 66 is a front view of the service portion body of FIG. 1;

FIG. 67 is a front perspective view of a conventional Chinese AK120 control valve;

FIG. 68 is a front perspective view of an unmodified service portion body for a rail control valve installed in the conventional Chinese AK120 control valve shown in FIG. 67;

FIG. 69 is a front perspective view of a service portion for a rail control valve installed in the conventional Chinese AK120 control valve using an adapter plate used in conjunction with a control valve system of a rail car, according to the present invention;

FIG. 70 is a front-left perspective view of the service portion shown in FIG. 69;

FIG. 71 shows various views of the adapter plate, according to the present invention;

FIG. 72 is a top view of each isolated component of the adapter plate assembly, according to the present invention;

FIG. 73 is a top view of the adapter plate, according to the present invention;

FIG. 74 is a left side view of the adapter plate shown in FIG. 73, according to the present invention;

FIG. 75 is a right side view of the adapter plate shown in FIG. 73, according to the present invention;

FIG. 76 is a front view of the adapter plate shown in FIG. 73, which is the face to which the Chinese AK120 charging check valve gets mounted, according to the present invention;

FIG. 77 is the side view shown in FIG. 74 with 2 mounting bolts shown through the adapter plate, according to the present invention;

FIG. 78 is a rear view of the adapter plate with a rubber gasket, which is the side of the adapter plate that mounts directly to the Chinese AK120 pipe bracket, according to the present invention;

FIG. 79 is a front perspective view of a conventional AK120 control valve without Chinese AK120 charging check valve assembly mounted to a pipe bracket by the adapter plate;

FIG. 80 is a close-up front perspective view of FIG. 79;

FIG. 81 is a front perspective view of the adapter plate mounted on the Chinese AK120 pipe bracket, according to the present invention;

FIG. 82 is a front right perspective view of FIG. 81;

FIG. 83 is a front left perspective view of FIG. 81;

FIG. 84 is a front perspective view of FIG. 81 with several ring gaskets;

FIG. 85 is a front perspective view of the Chinese AK120 charging check valve assembly mounted on the Chinese AK120 pipe bracket of conventional Chinese AK120 control valve using the adapter plate, according to the present invention;

FIG. 86 is a front perspective view of a modified surface portion with material machined off of the ECP mounting face, according to the present invention;

FIG. 87 is a front view of one embodiment of a cover plate having a uniform thickness, according to the present invention;

FIG. 88 is a front view of the cover plate shown in FIG. 87 mounted on a service portion installed in the conventional AK120 control valve according to the present invention;

FIG. 89 is a front view of one embodiment of a cover plate having a first section and a second section, according to the present invention;

FIG. 90 is a front view of the cover plate shown in FIG. 89 mounted on a service portion installed in the conventional AK120 control valve, according to the present invention;

FIG. 91 is perspective view of an as-cast, unmodified service portion for a rail control valve;

FIG. 92 is a perspective view of the as-cast service portion shown in FIG. 91 showing drilling locations for ports for connecting the brake cylinder exhaust core and holes for the cover plate, according to the present invention;

FIG. 93A is a perspective view of the as-cast service portion shown in FIG. 91 showing the drilling locations for ports for connecting the brake cylinder exhaust core and holes for the cover plate, the location of a ring gasket, and an outline of the cover plate covering a portion of the mounting face, according to the present invention;

FIG. 93B is a cross-sectional view of the cover plate of FIG. 93A;

FIG. 94 is a partial cross-sectional view showing the machined down ECP mounting face of the service portion maintaining a desired thickness of at least 0.25 inches between an auxiliary reservoir core and the mounting face;

FIG. 95 is a front perspective view of an ECP module mounted to the mounting face of the service portion;

FIG. 96A is a perspective view of a service graduating valve according to one embodiment of the ABDX-C service portion;

FIG. 96B is a perspective view of a service graduating valve according to one embodiment of the ABDX-C-AU/NZ service portion;

FIG. 97A is a bottom view of the service graduating valve shown in FIG. 96A;

FIG. 97B is a bottom view of the service graduating valve shown in FIG. 96B;

FIG. 98A is a right side view of the service graduating valve shown in FIG. 96A;

FIG. 98B is a right side view of the service graduating valve shown in FIG. 96B;

FIG. 99A is a cross-sectional view of the service graduating valve shown in FIG. 96A taken along line 16-16 of FIG. 97A;

FIG. 99B is a cross-sectional view of the service graduating valve shown in FIG. 96B;

FIG. 100A is a top view of the service graduating valve shown in FIG. 96A;

FIG. 100B is a top view of the service graduating valve shown in FIG. 96B;

FIG. 101A is a perspective view of a service slide valve according to one embodiment of the ABDX-C service portion;

FIG. 101B is a perspective view of a service slide valve according to one embodiment of the ABDX-C-AU service portion;

FIG. 101C is a perspective view of a service slide valve according to one embodiment of the ABDX-C-NZ service portion;

FIG. 102A is a top view of the service slide valve shown in FIG. 101A;

FIG. 102B is a top view of the service slide valve shown in FIG. 101B;

FIG. 102C is a top view of the service slide valve shown in FIG. 101C;

FIG. 103A is a bottom view of the service slide valve shown in FIG. 101A;

FIG. 103B is a bottom view of the service slide valve shown in FIG. 101B;

FIG. 103C is a bottom view of the service slide valve shown in FIG. 101C;

FIG. 104A is a rear view of the service slide valve shown in FIG. 101A and FIG. 101B;

FIG. 104B is a rear view of the service slide valve shown in FIG. 101C;

FIG. 105A is a front view of the service slide valve shown in FIG. 101A;

FIG. 105B is a front view of the service slide valve shown in FIG. 101B and FIG. 101C;

FIG. 106A is a left view of the service slide valve shown in FIG. 101A;

FIG. 106B is a left view of the service slide valve shown in FIG. 101B and FIG. 101C; and

FIG. 107 is an exploded view of a main piston assembly according to one embodiment of the ABDX-C service portion.

### DETAILED DESCRIPTION OF THE INVENTION

For the purposes of the description hereinafter, spatial orientation terms, if used, shall relate to the referenced embodiment as it is oriented in the accompanying drawing figures or otherwise described in the following detailed description. However, it is to be understood that the embodiments described hereinafter may assume alternative variations and embodiments. It is also to be understood that the specific devices illustrated in the accompanying drawing figures and described herein are simply exemplary and should not be considered limiting.

ECP Porting of a Service Portion of a Brake Control Valve

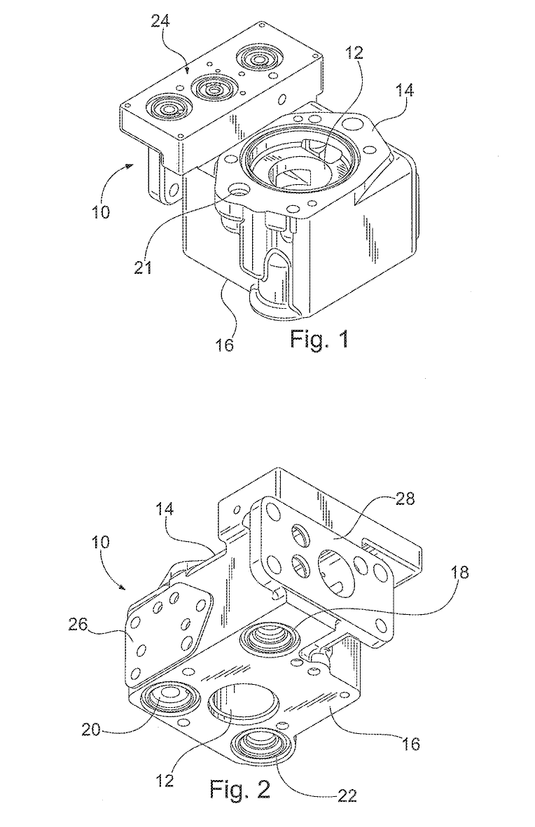

Referring to FIGS. 1-66 a service portion for a rail control valve includes a body defining a piston passageway, an inshot valve passageway, and a service accelerated release valve passageway.

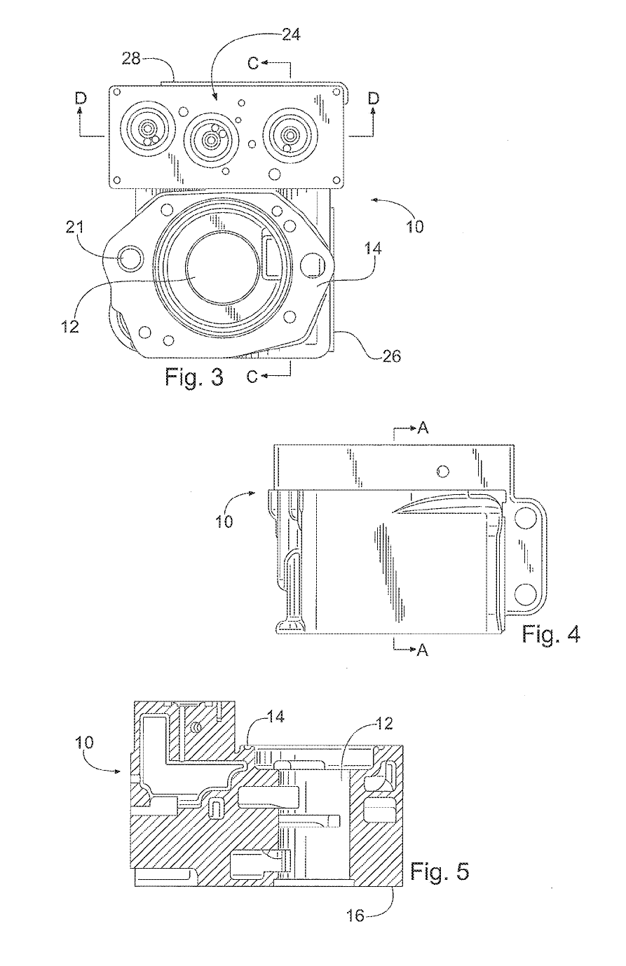

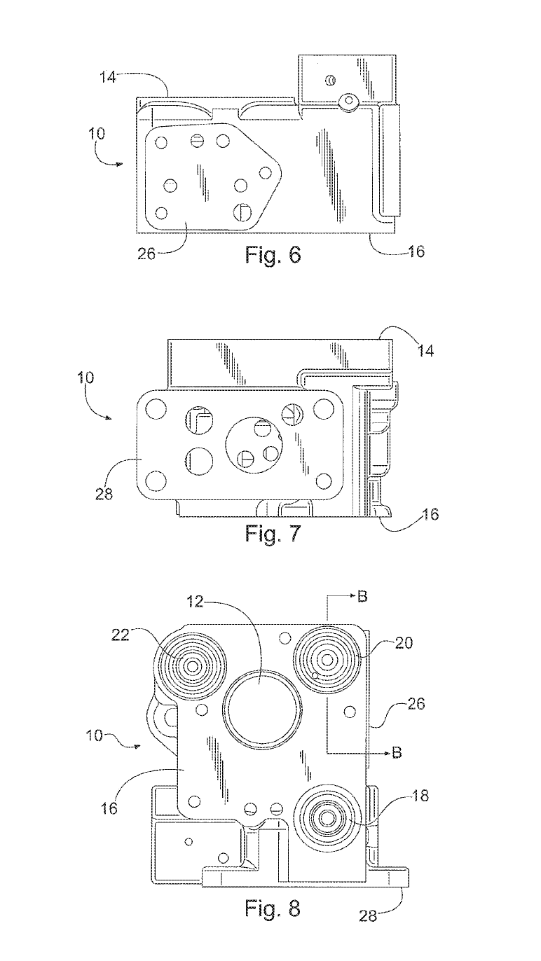

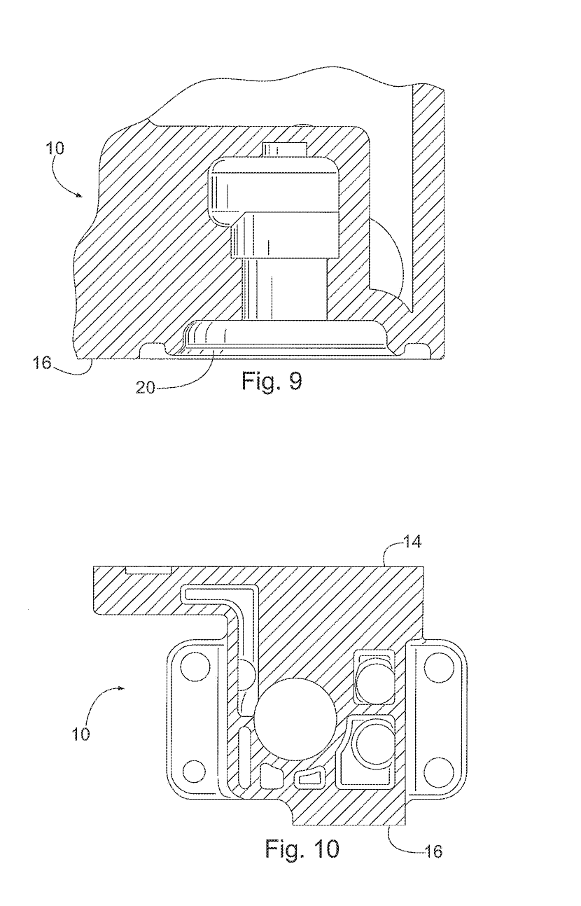

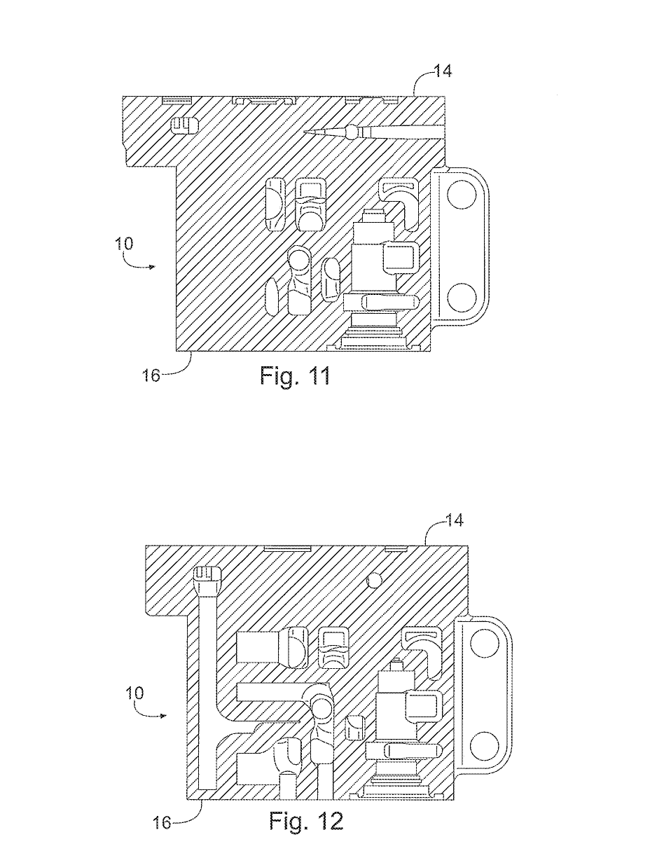

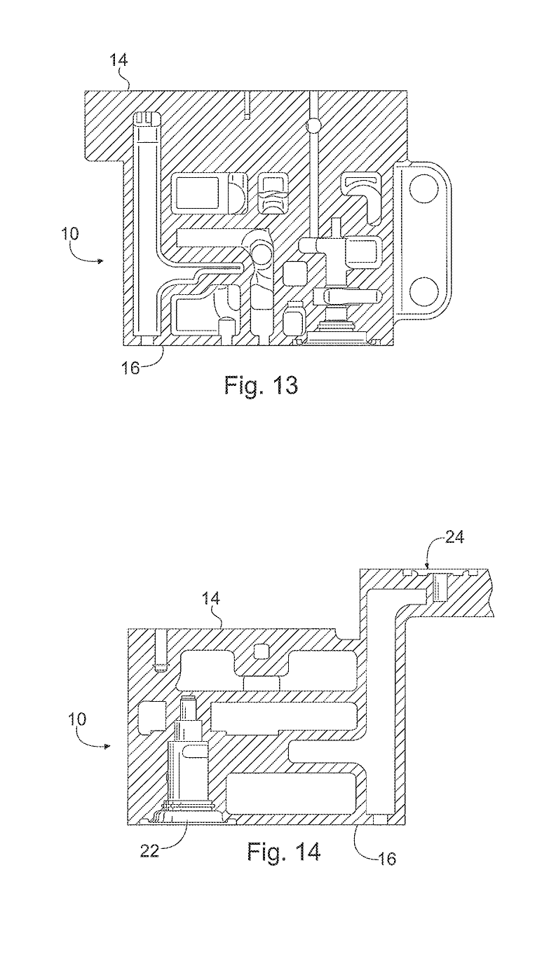

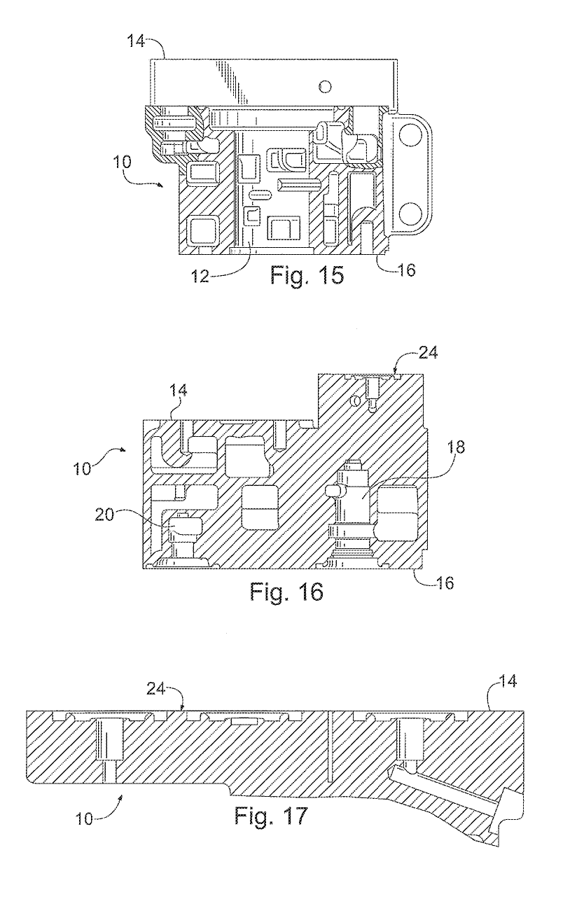

Referring to FIGS. 1-17, one embodiment of a body 10 for a service portion of a rail control valve is disclosed. The body 10 generally defines a piston passageway 12 axially extending from a top 14 of the body 10 to a bottom 16 of the body 10. The body 10 also defines an inshot valve passageway 18, a limiting valve passageway 20, and a service accelerated release (SAR) valve passageway 22 that each extend from the bottom 16 of the body in a direction toward the top 14 of the body. The body 10 also defines a back-flow check valve passageway 21 generally extending from the top 14 of the body 10 towards the bottom 16 of the body 10. The body 10 further includes ECP porting 24 configured to receive an ECP coin plate, a release valve receiving surface 26 configured to engage a release valve, and a pipe bracket receiving surface 28 configured to receive a pipe bracket. The piston passageway 12 receives a service piston assembly (not shown). The limiting valve passageway receives a brake cylinder limiting valve assembly (not shown). The inshot valve passageway and the SAR valve passageway receive an inshot valve and a SAR valve, respectively, which will be discussed in more detail below. The back-flow check valve assembly passageway 21 receives a back-flow check valve assembly, which is also discussed in more detail below.

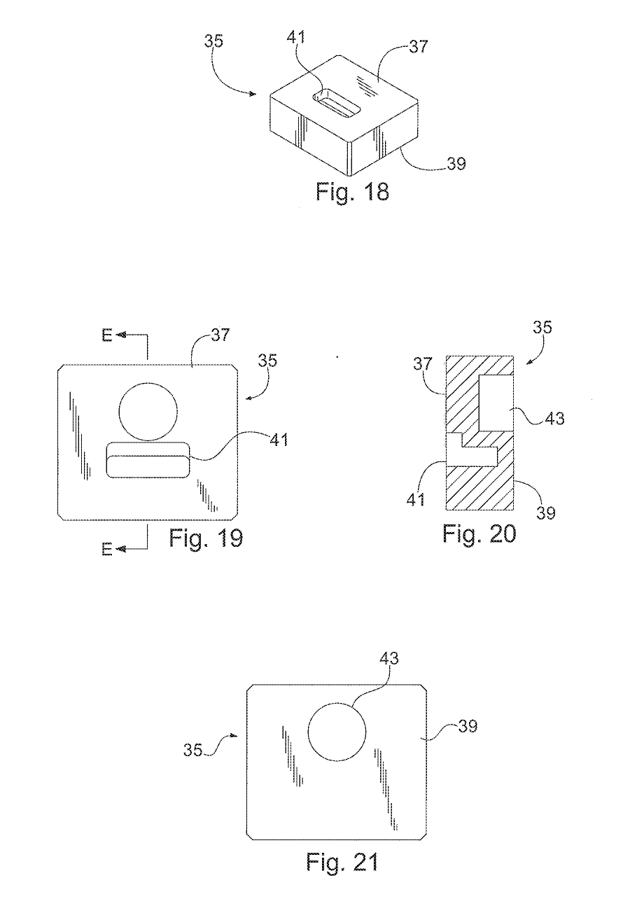

Referring to FIGS. 18-21, one embodiment of a grad valve 35 is disclosed. The grad valve 35 includes a first surface 37 and a second surface 39. The first surface 37 defines a generally rectangular-shaped opening 41 and the second surface defines a generally circular-shaped opening 43. The grad valve 35 forms part of the overall service piston assembly (not shown) and is received within the piston passageway 12 of the body 10.

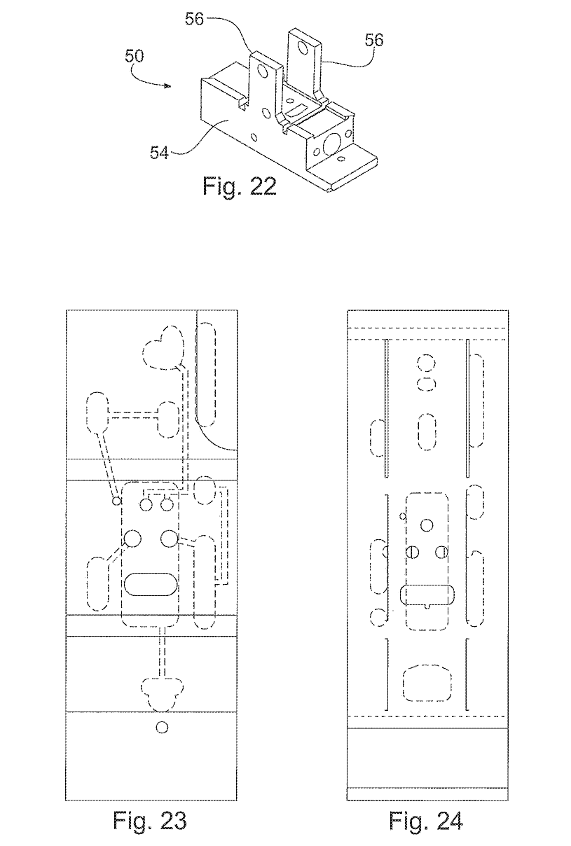

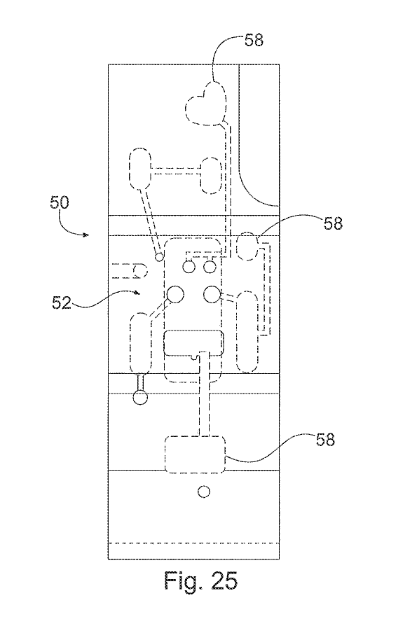

Referring to FIGS. 22 and 25, one embodiment of a slide valve 50 and its corresponding porting pattern 52 is disclosed. The slide valve 50 is also part of the service piston assembly and is received within the piston passageway 12 of the body 10. The slide valve 50 includes a body 54 having a pair of extensions 56. The slide valve body 54 defines a plurality of passages 58 to form the porting pattern 52 as shown in FIG. 25. FIGS. 23 and 24 show the porting pattern for conventional ABDX and China 120-1 slide valves.

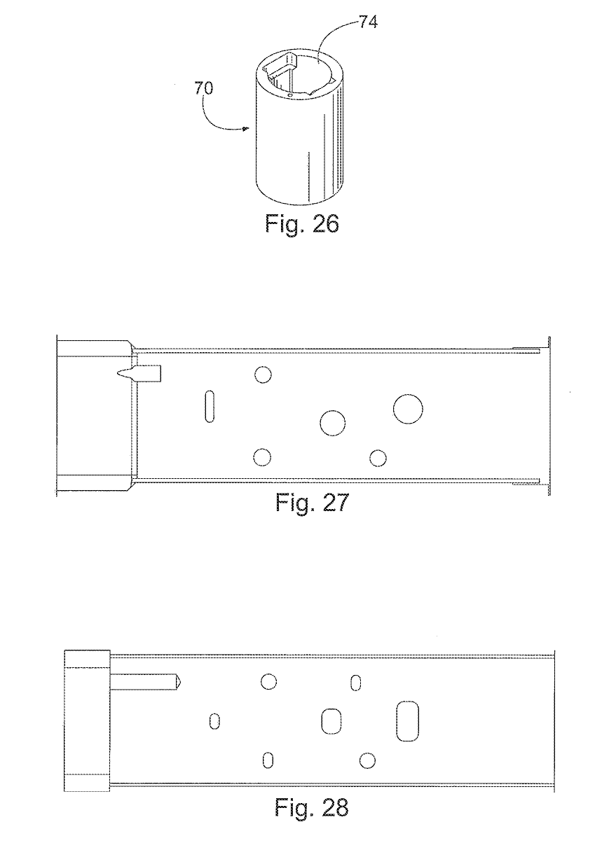

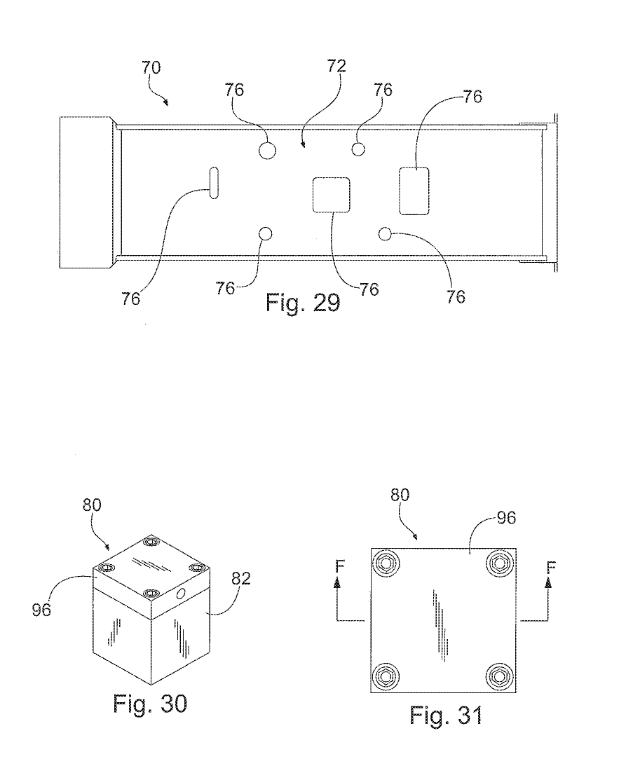

Referring to FIGS. 26 and 29, one embodiment of a main bushing 70 and its corresponding porting pattern 72 is disclosed. The main bushing 70 is received within the piston passageway 12 of the body 10 and cooperatively engages the slide valve 50. The main bushing 70 is generally cylindrical-shaped having a central passageway 74 for receiving the slide valve 50 and the remaining piston assembly. The bushing 70 defines a plurality of passages 76 to form the porting pattern 72 as shown in FIG. 29. FIGS. 27 and 28 show the porting pattern for conventional ABDX and China 120-1 bushings.

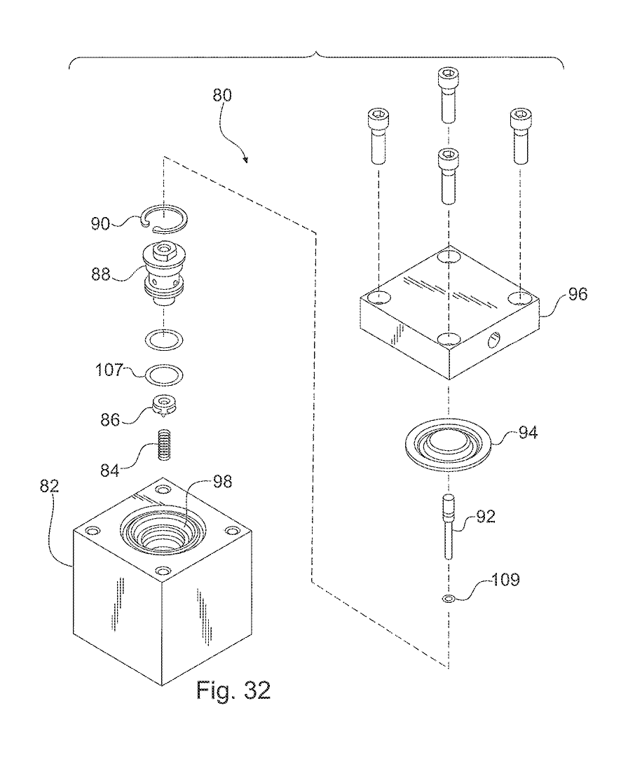

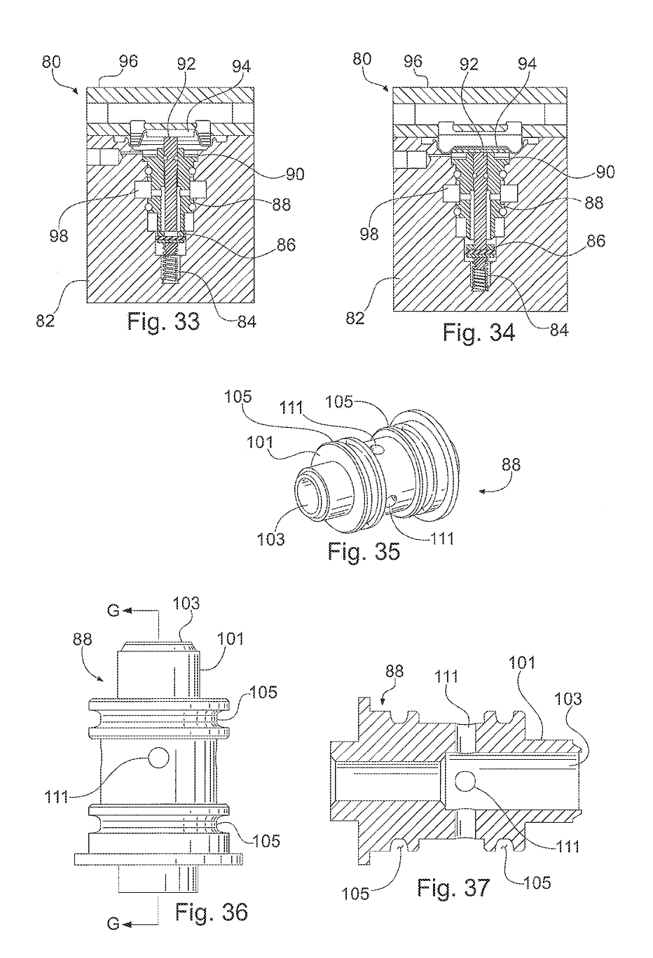

Referring to FIGS. 30-37, one embodiment of a SAR valve 80 is disclosed. The SAR valve 80 includes a body 82, a spring 84, a check valve 86, a bushing 88, a retaining ring 90, a plunger 92, a diaphragm 94, and a cover 96. The body 82 defines a passageway 98 for receiving the spring 84, check valve 86, bushing 88, retaining ring 90, plunger 92, and diaphragm 94. Although the body 82 is shown as a distinct component, the SAR valve 80 may be received in the SAR valve passageway 22 of the service portion body 10 of the control valve as discussed above. In particular, the spring 84, check valve 86, bushing 88, retaining ring 90, plunger 92, and diaphragm 94 of the SAR valve 80 would be received by the SAR valve passageway 22 of the service portion body 10 in the same manner as shown in FIGS. 30-34. The SAR valve 80 has a closed position (shown in FIG. 33) and an open position (shown in FIG. 34). The SAR valve bushing 88, shown more clearly in FIGS. 35-37, includes a body 101 defining a central passageway 103. The bushing 88 includes a pair of spaced seats 105 for receiving o-rings 107. The plunger 92 is axially moveable within the central passageway 103 of the bushing 88 and also includes an o-ring 109. The body 101 of the bushing also defines a pair of radially extending passages 111 that intersect the central passageway 103. The diaphragm 94 may be a thin section rubber compound diaphragm having internal fabric and a brass insert.

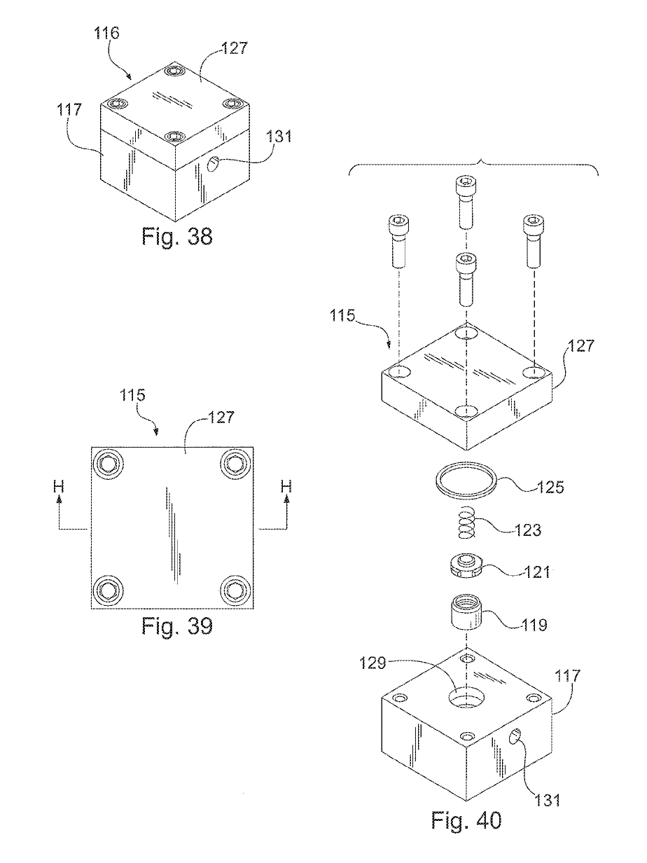

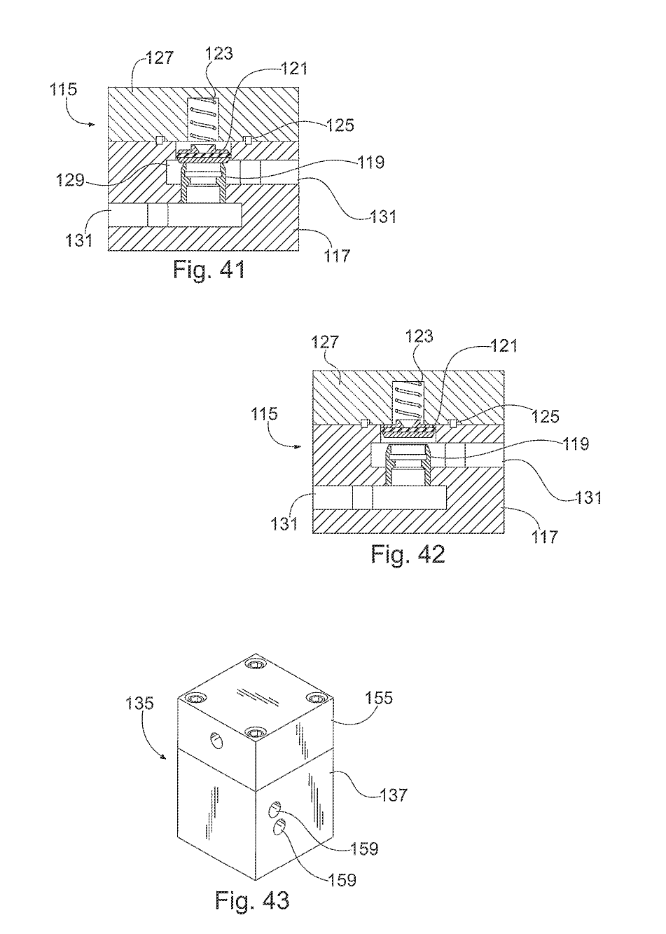

Referring to FIGS. 38-42, one embodiment of a back-flow check valve 115 is disclosed. The back-flow check valve 115 includes a body 117, a bushing 119, a check valve member 121, a spring 123, a gasket 125, and a cover 127. The body 117 defines a central passageway 129 for receiving the bushing 119, check valve member 121, and spring 123. Although the back-flow check valve 115 is shown as a distinct component, the back-flow check valve 115 may be received in the back-flow check valve passageway 21 in the service portion body 10 of the control valve. The back-flow check valve 115 has a closed position (shown in FIG. 41) and an open position (shown in FIG. 42). The body 117 also defines a pair of passageways 131 extending from each side of the body 117, which are in fluid communication with the central passageway 129.

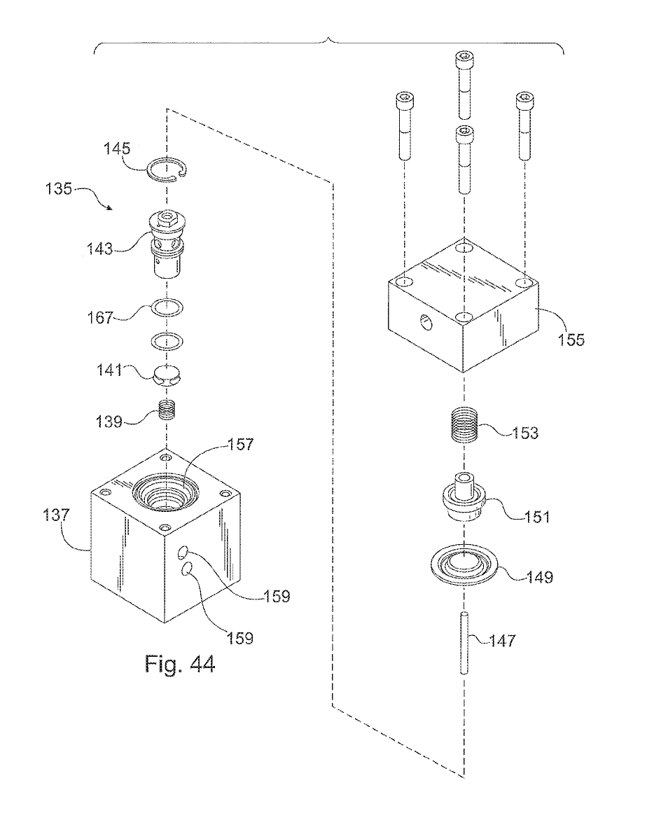

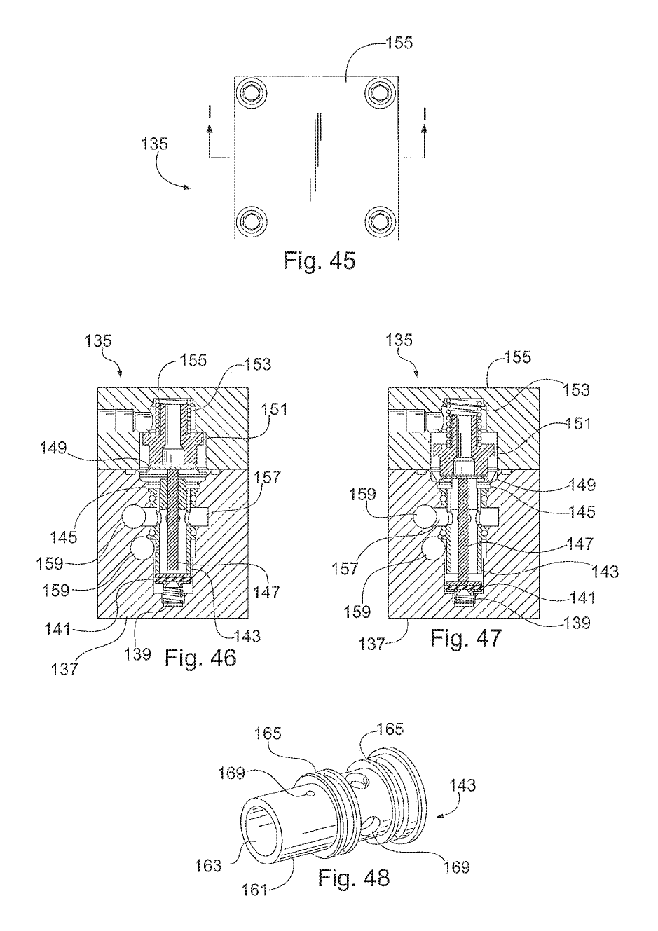

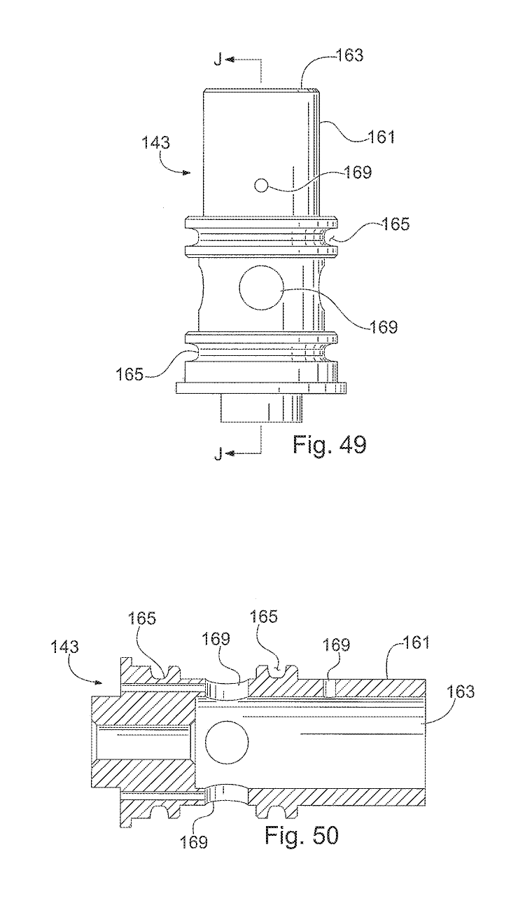

Referring to FIGS. 43-50, one embodiment of an inshot valve 135 is disclosed. The inshot valve 135 includes a body 137, a valve spring 139, a check valve 141, a bushing 143, a retaining ring 145, a pushrod 147, a diaphragm 149, a follower 151, a follower spring 153, and a cover 155. The inshot valve body 137 defines a central passageway 157 for receiving the valve spring 139, check valve 141, bushing 143, retaining ring 145, pushrod 147, diaphragm 149, follower 151, and follower spring 153. Although the inshot valve body 137 is shown as a distinct component, the inshot valve 135 may be received in the inshot valve passageway 18 of the service portion body 10 of the control valve as discussed above. In particular, the valve spring 139, check valve 141, bushing 143, retaining ring 145, pushrod 147, diaphragm 149, follower 151, and follower

spring 153 would be received by the inshot valve passageway 18 of the service portion body 10 in the same manner as shown in FIGS. 43-50. The inshot valve body 137 also defines a pair of passageways 159 extending from a side of the body 137, which are in fluid communication with the central passageway 157. The inshot valve 135 has a closed position (shown in FIG. 46) and an open position (shown in FIG. 47). The inshot valve bushing 143, shown more clearly in FIGS. 48-50, includes a body 161 defining a central passageway 163. The bushing 143 includes a pair of seats 165 for receiving o-rings 167. The body 161 of the bushing 143 also defines a plurality of radially extending passageways 169 that are in fluid communication with the central passageway 163 of the bushing 143. The pushrod 147 is movable within the central passageway 163 of the bushing 143. The diaphragm 149 may be a thin section rubber compound diaphragm having internal fabric and a brass insert.

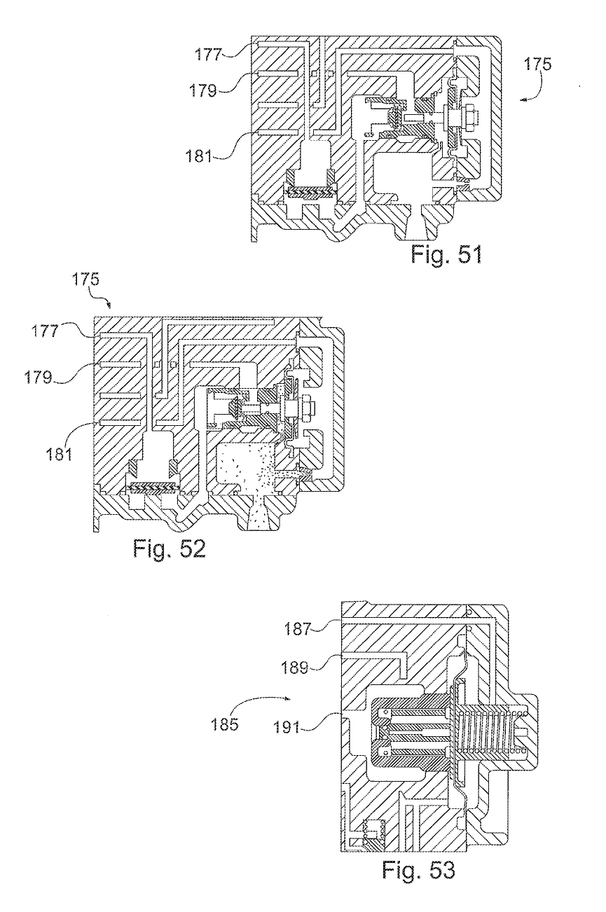

Referring to FIGS. 51 and 52, a release and charging position and an accelerated release position of a conventional China 120-1 accelerated release valve 175 are shown. The conventional China 120-1 accelerated release valve 175 includes an accelerated release passageway 177, a brake pipe passageway 179, and a brake cylinder 181 (retainer exhaust) passageway. The conventional China 120-1 accelerated release valve 175 uses retainer exhaust 181 to actuate accelerated release and has a floating piston design, which can be susceptible to vibration damage. A back-flow check valve is needed for dry charge to prevent accelerated release reservoir charging through the accelerated release valve 175. The back-flow check valve also prevents accelerated release charging through the accelerated release valve while brake cylinder pressure in the retainer exhaust port is still somewhat high (above 4-5 psi).

Referring to FIG. 53, a conventional ABDX SAR valve 185 is shown. The conventional ABDX SAR valve 185 utilizes an auxiliary reservoir passageway 187, a brake pipe passageway 189, and an emergency reservoir passageway 191. The conventional ABDX SAR valve 185 uses Brake Pipe/Auxiliary differential to actuate the SAR valve. The use of a back-flow check valve is not necessary.

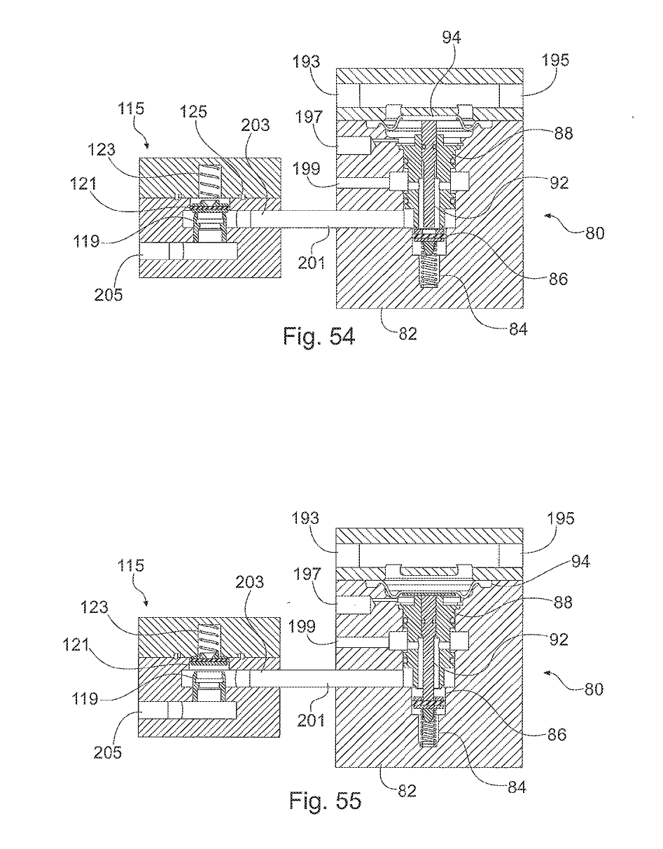

Referring to FIGS. 54 and 55, the SAR valve 80 and back-flow check valve 115 shown in FIGS. 30-42 and described above are shown operatively connected to each other. The SAR valve 80 includes a brake cylinder exhaust passageway 193, first and second atmospheric vent passageways 195, 197, a brake pipe passageway 199, and a check valve passageway 201. The back-flow check valve 115 includes a check valve passageway 203 and an accelerated release reservoir passageway 205. The SAR valve 80 uses brake cylinder exhaust pressure 193 to open the SAR valve 80. The open position of the SAR valve 80 and back-flow check valve 115 is shown in FIG. 55 and the closed position of the SAR valve 80 and back-flow check valve 115 is shown in FIG. 54. After the SAR valve 80 opens, the valve allows accelerated release reservoir pressure 205 to flow into the brake pipe to help recharge the brake pipe.

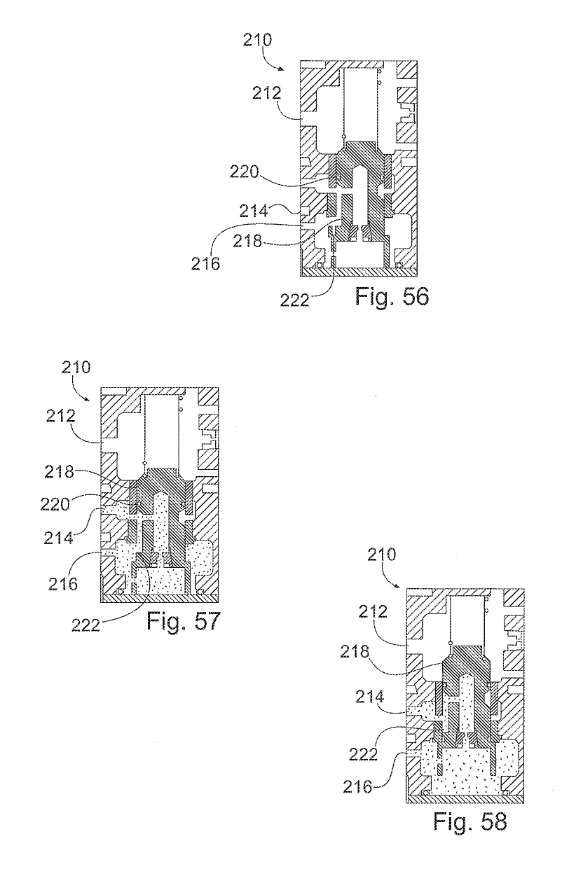

Referring to FIGS. 56-58, a release and charging position, a service position, and an emergency position of a conventional China 120-1 inshot valve 210 are shown. The conventional China 120-1 inshot valve 210 includes a brake pipe passageway 212, a brake cylinder “out” passageway 214, and a brake cylinder “in” passageway 216. In the release and service positions (FIGS. 56 and 57), a spool 218 of the valve has only one o-ring 220 in bore and brake pipe pressure acting on the o-ring 220 along with the spring holding the inshot spool in the open position. When brake pipe pressure is removed or significantly lower than brake cylinder pressure, the spool 218 moves up to the closed position and the other o-ring 222 seals off the unrestricted flow of brake cylinder “in” 216 to brake cylinder “out” 214. In the closed position, brake cylinder pressure is restricted by the choke in the spool 218.

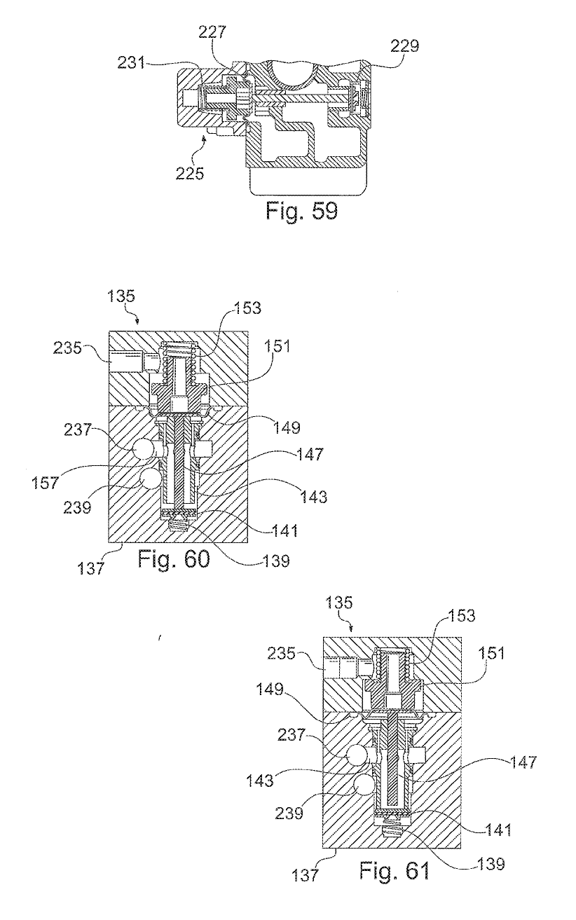

Referring to FIG. 59, a conventional ABDX inshot valve 225 is shown. In the release position, there is no pressure on the diaphragm 227 or check valve 229 and the spring 231 on the left of the diaphragm 227 holds the inshot valve 225 open. During service applications, brake cylinder pressure is on both sides of the diaphragm 227 and flows unrestricted past the check

valve 229, because the diaphragm spring 231 is holding the inshot open. During emergency applications, the high pressure spool cuts off the feed of brake cylinder pressure to the spring side of the diaphragm 227. Brake cylinder pressure continues to increase on the right side of the diaphragm 227 and eventually overcomes the spring 231 and moves the diaphragm 227 to the left. After the diaphragm 227 is moved, the flow of brake cylinder pressure along with the check valve spring close the check valve 229 and any further brake cylinder build-up is restricted through a hole in the check valve seat.

Referring to FIGS. 60 and 61, the inshot valve 135 shown in FIGS. 43-50 and described above is shown in a closed position and an open position. The inshot valve 135 includes a brake pipe passageway 235, a brake cylinder “out” passageway 237, and a brake cylinder “in” passageway 239. The inshot valve 135 is normally in the open position (shown in FIG. 60) allowing unrestricted flow of brake cylinder pressure (brake cylinder “in” 239 to brake cylinder “out” 237). When brake pipe pressure is removed or significantly lower than brake cylinder pressure, the diaphragm 149 moves upward allowing the check valve 141 to close. When closed, the brake cylinder pressure flow through the inshot valve 135 is restricted by the opening in the side 169 of the bushing 143 to slow down the build-up of brake cylinder pressure (inshot function).

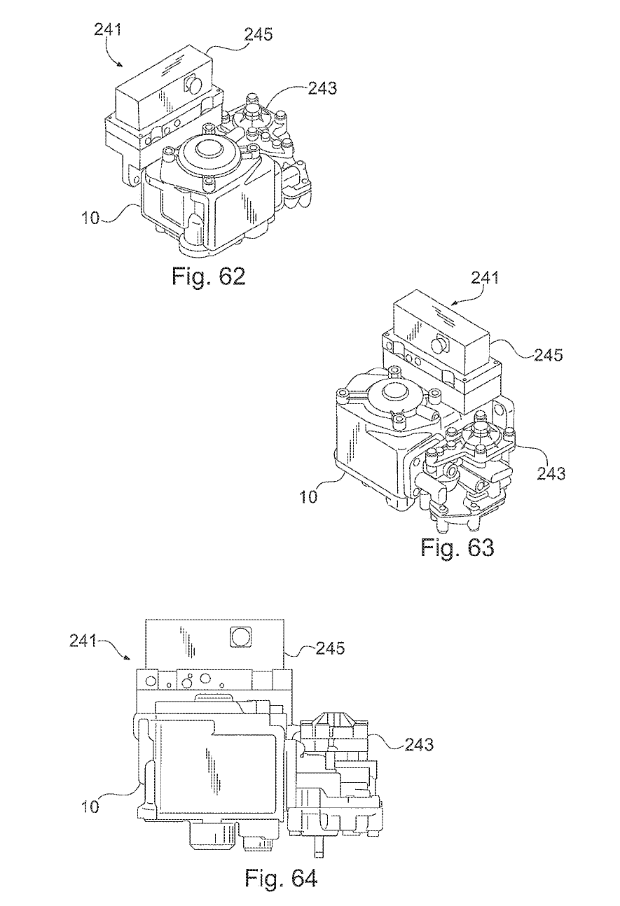

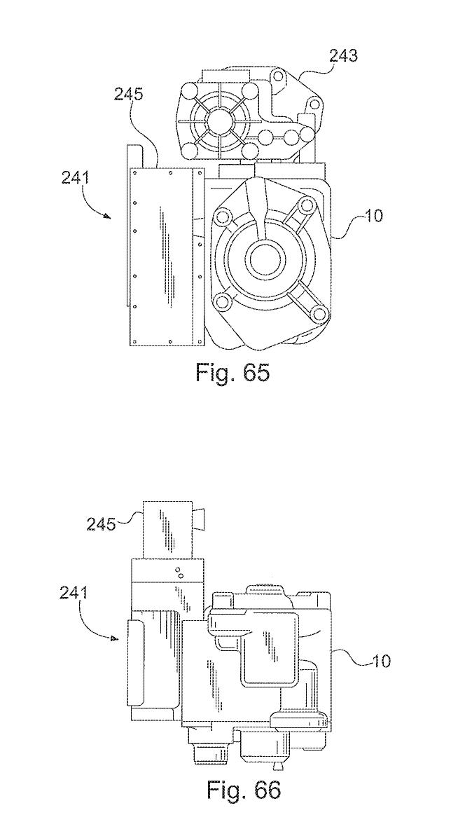

Referring to FIGS. 62-66, an assembled service portion 241 of a brake control valve is shown. The service portion 241 includes the body 10 having, among other components, the SAR valve 80, back-flow check valve 115, and inshot valve 135. A release valve 243 is also attached to the body 10 at the release valve receiving surface 26. The service portion 241 is shown with an ECP coin plate 245 engaged with the ECP porting 24 on the body 10.

The service portion 241 including the body 10, main piston bushing 70, slide valve 50, grad valve 35, SAR valve 80, back-flow check valve 115, and inshot valve 135 may be used in place of the Chinese 120 or 120-1 and provides an extended service life and more reliable operation relative to conventional valves. The various diaphragms in the service portion are suitable for low temperature operation and extend the service life. In addition, the service portion incorporates air passages in the main body that provide for the addition of an Electronically Controlled Pneumatic (ECP) brake system. The air passages for the ECP brake system may be formed integrally with the main body. The service portion 241 may also be utilized in the American Association of Railroads (AAR) market, where typical control valves are composed of a pipe bracket, a service portion, and an emergency portion. The pipe bracket serves primarily as a mounting bracket for the service and emergency portion. The service portion 241 may combine most operational functions into the service portion and leave a vent valve function in the emergency portion. Additionally, previous features found in the emergency portion of conventional AAR control valves, such as the accelerated application and in-shot, are moved to the service portion 241 of the control valve. Additionally, an Electronically Controlled Pneumatic (ECP) brake capability is provided in the main body of the service portion 241 of the control valve described in detail herein. With the control valve described in detail herein, it is easier to determine which portion of the control valve is defective and replace just the defective portion. Further, as most of the operational functions are located in the service portion 241, replacing just that portion typically will correct any problems. The service portion 241 of the control valve includes air passages in the service portion body that allow ECP overlay functionality to be included in the service portion. The service portion of the control valve may also specifically include the in-shot valve. Moreover, the vent valve function in the emergency portion of the control valve may use brake pipe and quick action chamber volume.

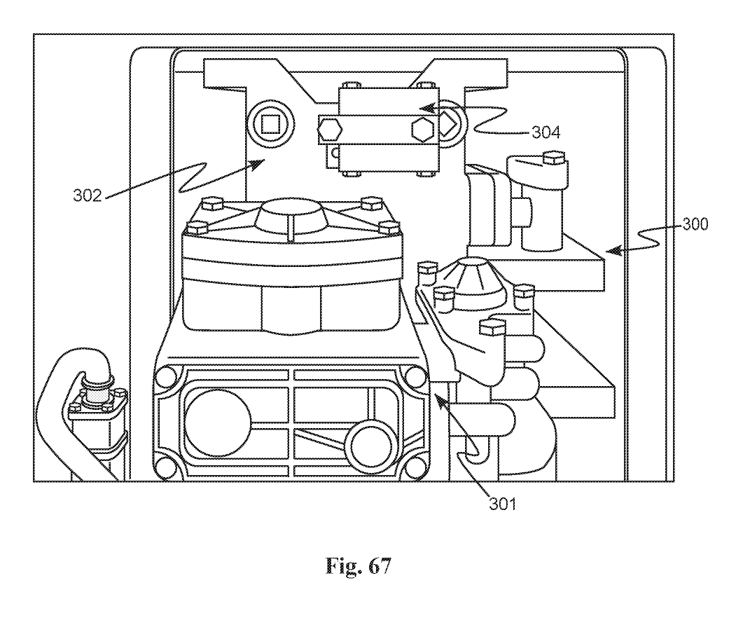

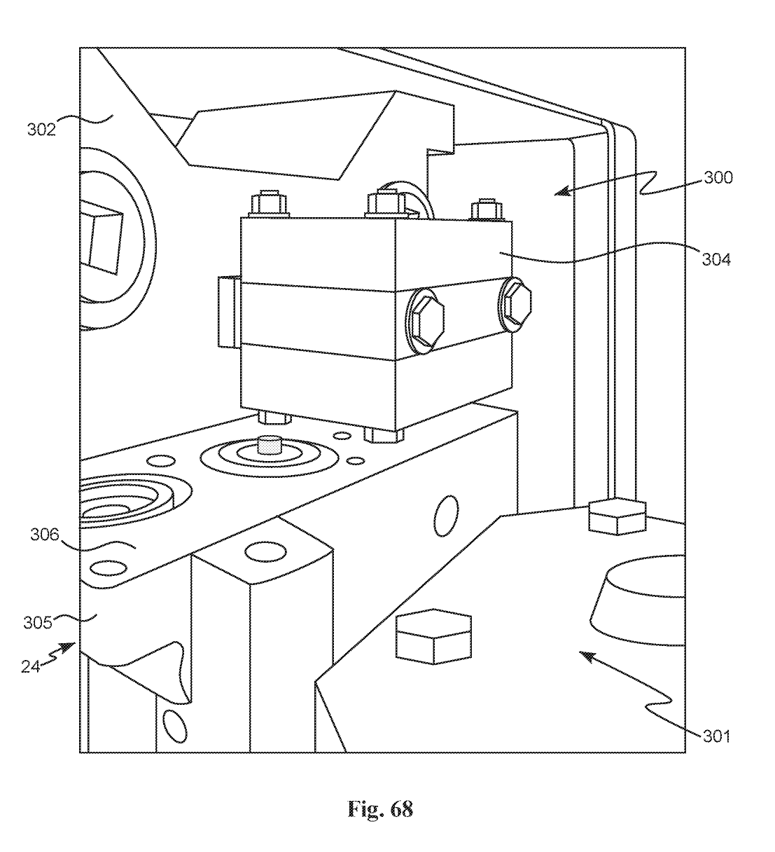

FIGS. 67-68 illustrate one embodiment of a Chinese AK120 control valve system 300 used in Australia. The Chinese AK120 control valve system 300 includes a Chinese AK120 pipe

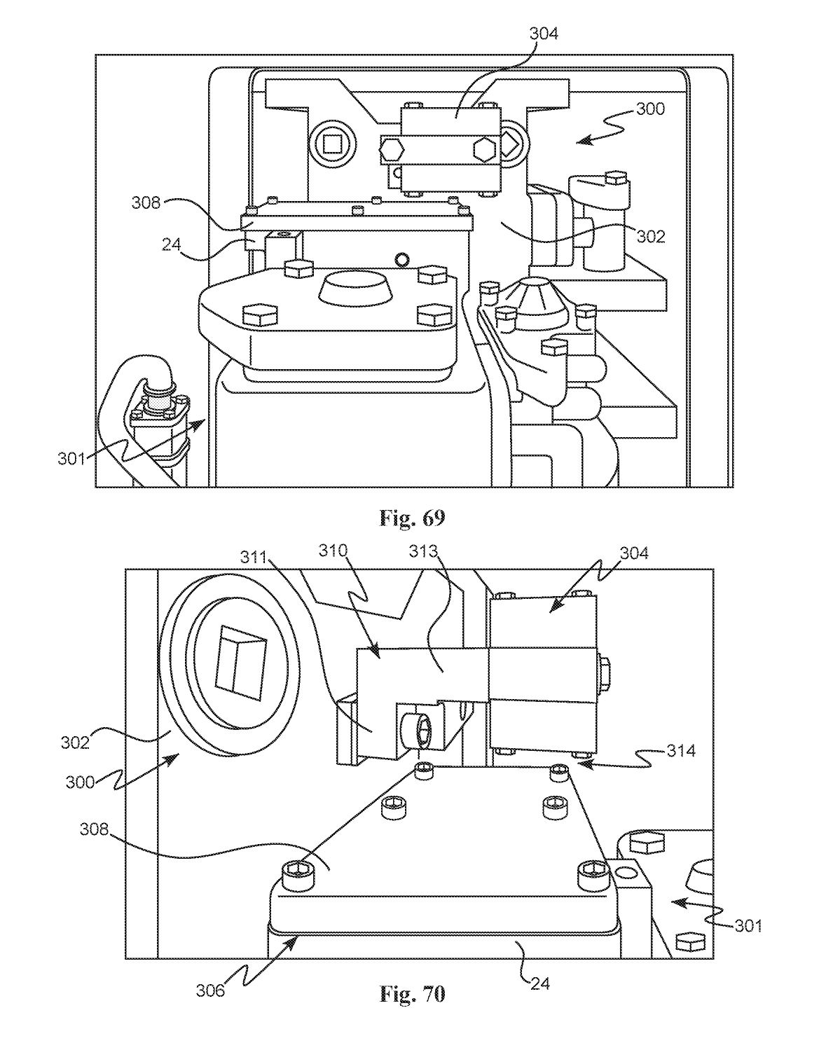

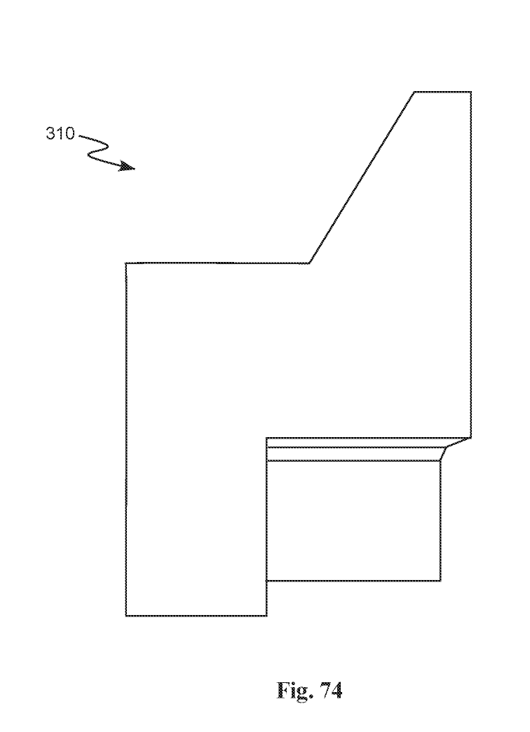

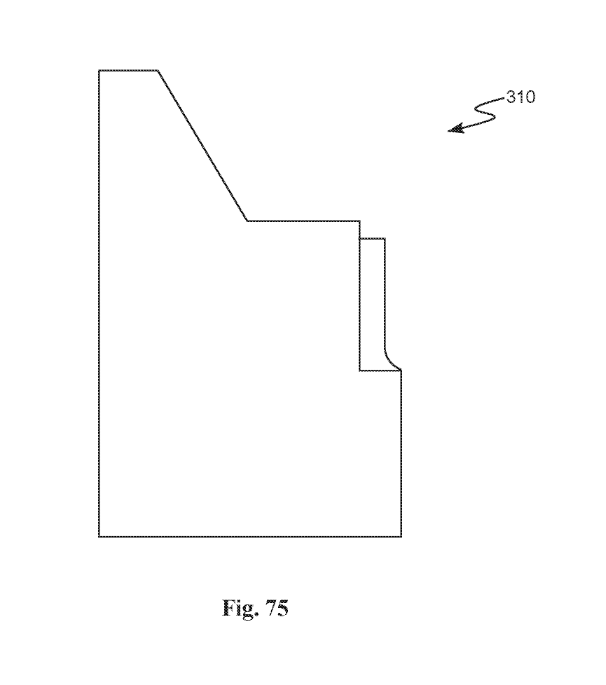

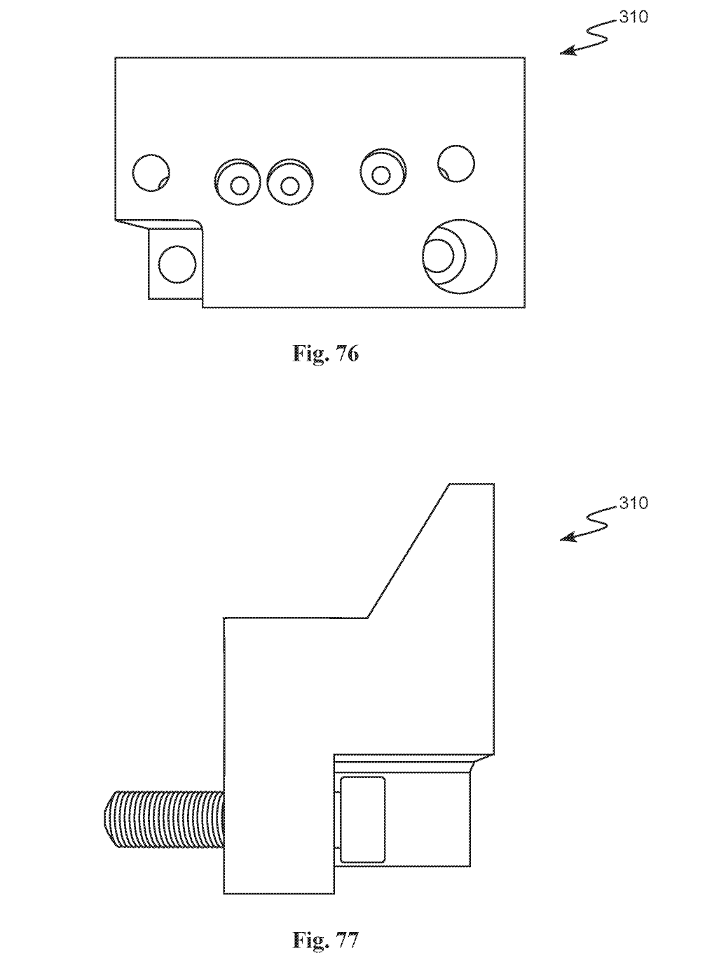

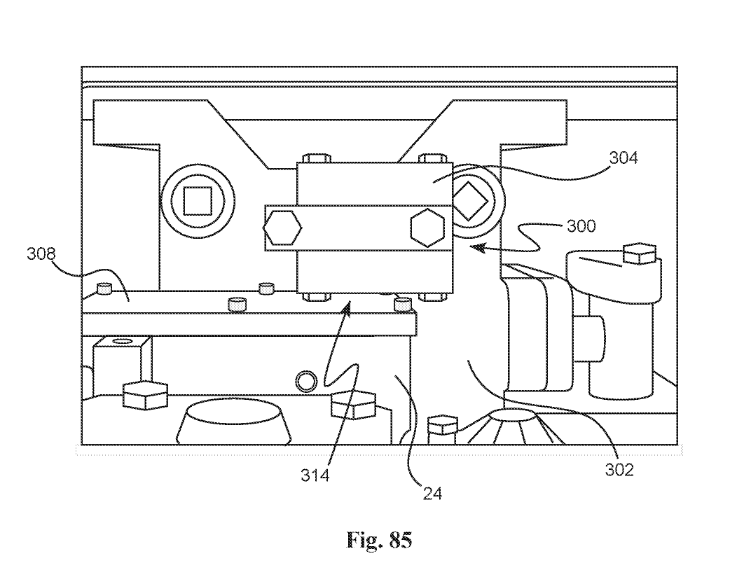

bracket 302, and a Chinese AK120 charging check valve assembly 304. FIG. 68 shows the previously described service portion of a rail control valve installed in the Chinese AK120 control valve system 300 used in Australia. As can be seen in FIG. 68, the ECP porting 24 is adjacent the Chinese AK120 charging check valve assembly 304. FIGS. 69-94 show embodiments of modifications made to the service portion and/or the control valve system such that the service portion is compatible with at least the Chinese AK120 control valve system 300 used in Australia and New Zealand.

Referring to FIGS. 69-85, an adapter plate 310 is mounted to a pipe bracket 302 so that a service portion 301 is compatible with a control valve system 300, for example, the service portion 301 and the charging check valve assembly 304 do not interfere with one another. The adapter plate 310 may be mounted to a pipe bracket interface 303 of the pipe bracket 302 of the rail control valve system 300.

According to one embodiment, the adapter plate 310 is configured to raise the charging check valve assembly 304 such that there is a clearance 314 between the charging check valve assembly 304 and the service portion 301 when the service portion 301 is installed in the control valve system 300. The clearance 314 may be a vertical gap between the installed service portion 301 and the charging check valve assembly 304 such that the installed service portion 301 and the charging check valve assembly 304 are not in contact, and enable components to be located below the charging check valve assembly 304. In other words, the ports drilled into the mounting face 306 may be unobstructed by the charging check valve assembly 304. In some embodiments, the clearance 314 between the installed service portion 301 and the charging check valve assembly 304 is less than one inch. In other embodiments, the clearance 314 is greater than one inch, and the clearance 314 can be any suitable distance between the installed service portion 301 and the charging check valve assembly 304, based on the design of the service portion 301 and the control valve system 300.

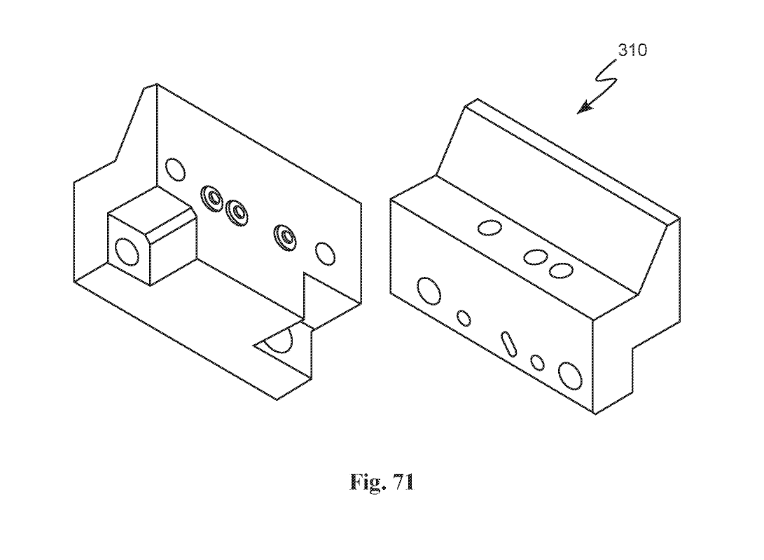

In another embodiment, the adapter plate 310 raises the charging check valve assembly 304 such that there is a clearance 314 between the charging check valve assembly 304 and the service portion 301 when the service portion 301 is installed in the control valve system 300 when the service portion 301 includes an ECP porting 24. This can be seen, for example, in FIGS. 69-70. In yet another embodiment, the adapter plate 310 raises the charging check valve assembly 304 such that there is a clearance 314 between the charging check valve assembly 304 and the service portion 301 when the service portion 301 includes a cover plate 308 mounted to a mounting face 306 of the ECP porting 24. This is also shown in FIGS. 69-70.

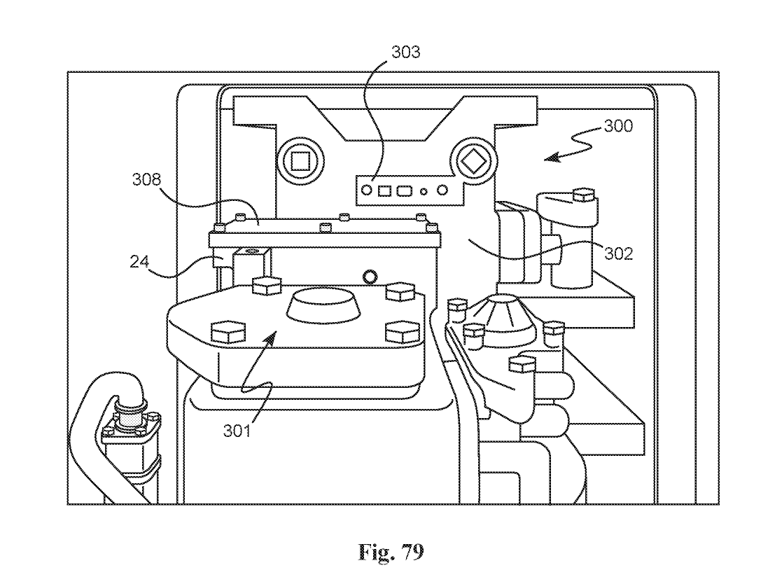

Referring to FIG. 70 and FIG. 79, the adapter plate 310 may be L-shaped and include a vertical leg 311 and a horizontal leg 313. The vertical leg 311 may form the connection between the adapter plate 310 and the pipe bracket interface 303 (the adapter plate 310 may be mounted to the pipe bracket 302 via the pipe bracket interface 303). The L-shaped adapter plate 310 may further elevate the charging check valve assembly 304 by the vertical leg 311.

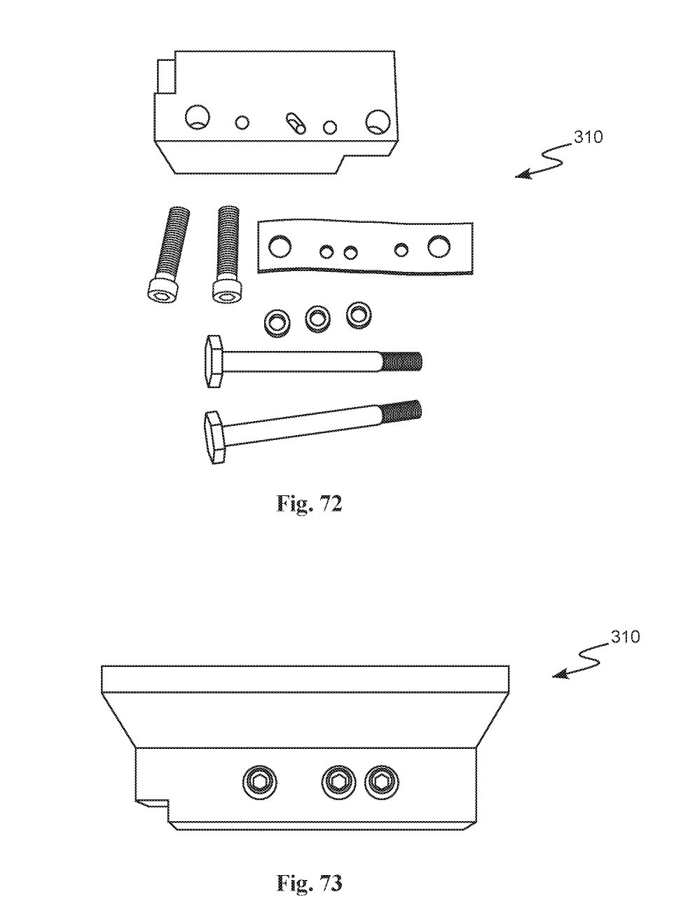

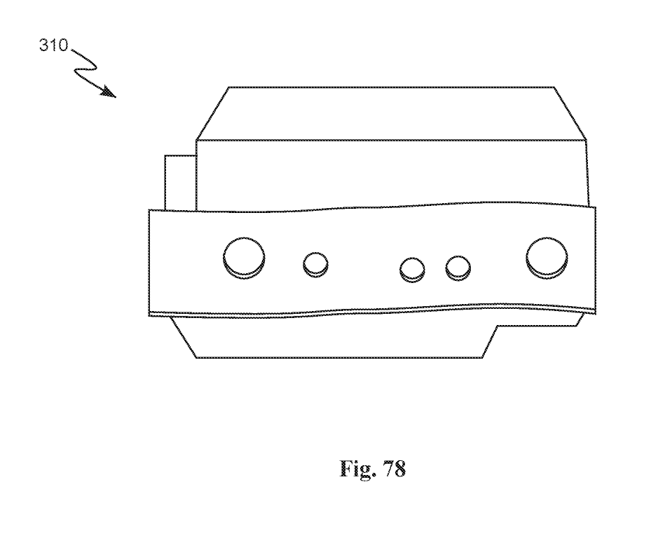

As shown in FIG. 72, the adapter plate 310 can include rubber seals/flat rubber gaskets and fasteners to mount the adapter plate 310 to the pipe bracket 302. The adapter plate 310 can be mounted to pipe bracket 302 by any suitable method of securely fastening the adapter plate 310 to the pipe bracket 302, such as 10 mm diameter mounting bolts, as shown in FIG. 77. The rubber seal/flat rubber gasket is included between the adapter plate 310 and the pipe bracket 302 (see

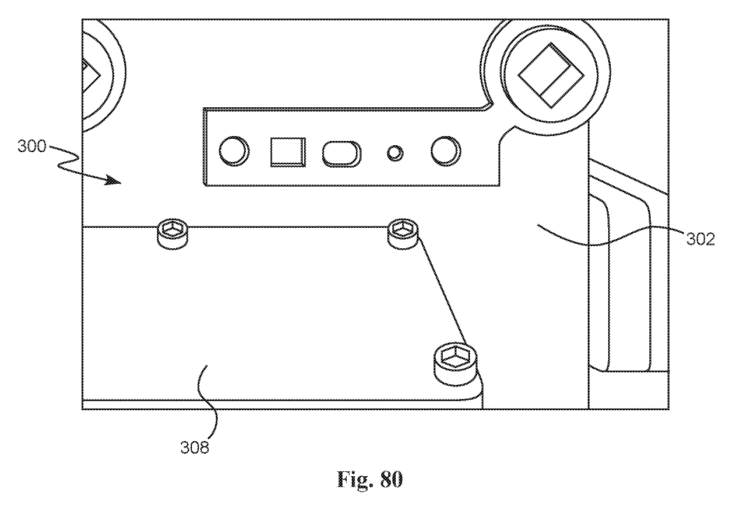

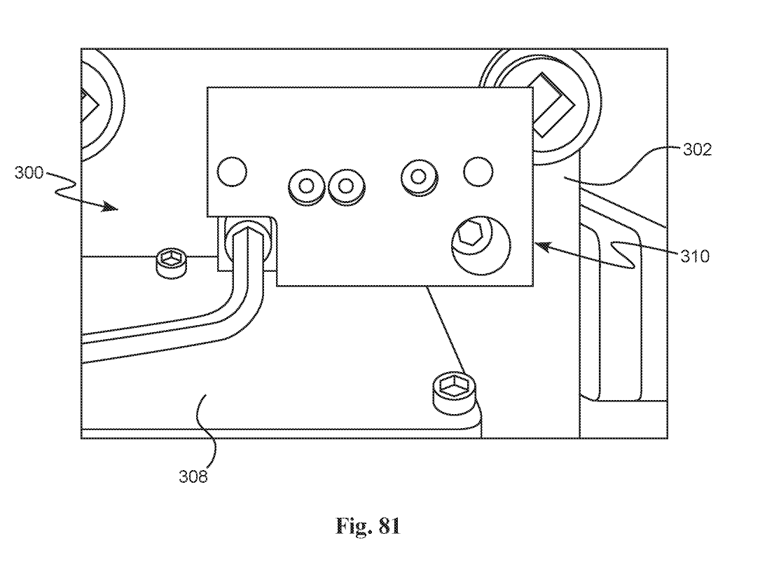

FIG. 78). FIGS. 79-80 show an embodiment in which the pipe bracket 302 includes a plurality of holes for receiving the fasteners, such as 10 mm mounting bolts, of the adapter plate 310 so that the adapter plate 310 can be mounted to the pipe bracket 302 at the pipe bracket interface 303. Referring to FIG. 81, the adapter plate 310 can be secured to the pipe bracket 302 by any suitable means, such as by using an Allen wrench or screwdriver, to tighten the fasteners.

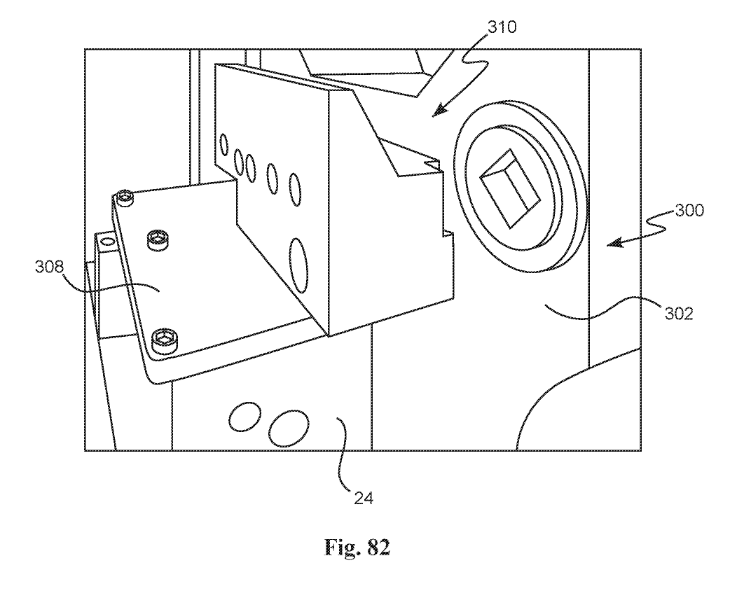

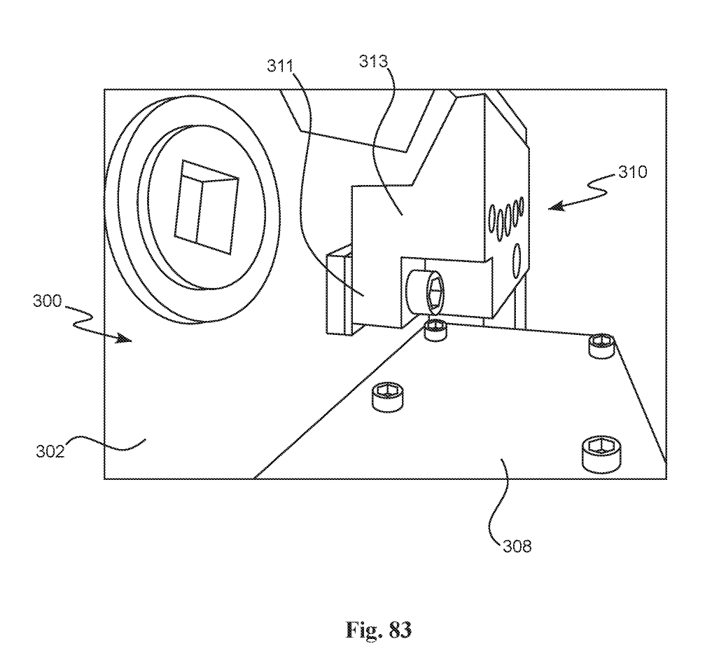

In one embodiment, for instance as shown in FIGS. 82-83, the adapter plate 310 has a plurality of holes configured to receive the charging check valve assembly 304 of the control valve system 300. The charging check valve assembly 304 can be mounted to the adapter plate 310 by any suitable fastening means, such by using two 10 mm diameter studs or by using the appropriate length 10 mm diameter bolts.

With continued reference to FIGS. 82-83, the plurality of holes of the adapter plate 310 configured to receive the charging check valve assembly 304 can be raised higher when mounted to the pipe bracket interface 303. This configuration allows for the charging check valve assembly 304 to be elevated using the adapter plate 310 (see e.g., FIG. 70) so that there is a sufficient clearance 314 between the service portion 301 and the raised charging check valve assembly 304 (so that the ports in the mounting face 306 can be properly isolated and sealed by cover plate 308 and fasteners).

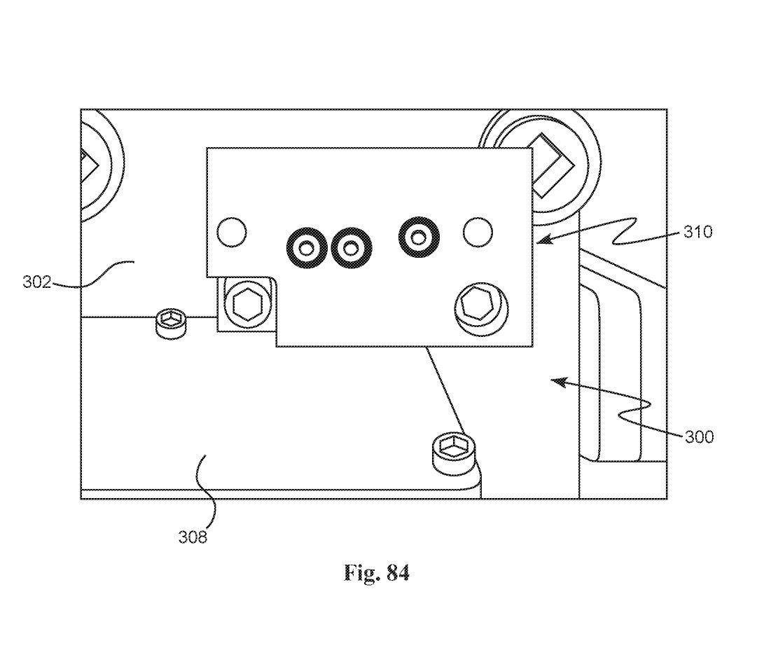

Referring to FIG. 84, several ring gaskets are provided to act as a seal between the adapter plate 310 and the charging check valve assembly 304. In FIG. 84, for instance, three such ring gaskets are provided.

According to one embodiment, a method is used to install the service portion 301 of a rail control valve in a control valve system of a rail car. According to this method, an adapter plate 310, as previously described, can be provided. One end of the adapter plate 310 can be mounted to the pipe bracket interface 303 using any suitable means, such as by 10 mm mounting bolts. The charging check valve assembly 304 can be mounted on another end of the adapter plate 310 so as to raise the charging check valve assembly 304 to a higher position than it would have been without using the adapter plate 310. The method can also include installing the service portion 301 of a rail control valve in the control valve system 300. By this method, a clearance 314 is provided between the charging check valve assembly 304 and the installed service portion 301. In another embodiment of the method, the adapter plate 310 raises the charging check valve assembly 304 such that there is clearance 314 between the charging check valve assembly 304 and the service portion 301 when the service portion 301 includes an ECP porting 24 with a mounting flange 305 having a mounting face 306. In yet another embodiment of the method, the adapter plate 310 raises the charging check valve assembly 304 such that there is clearance 314 between the charging check valve assembly 304 and the service portion 301 when there is a cover plate 308 mounted to the mounting face 306.

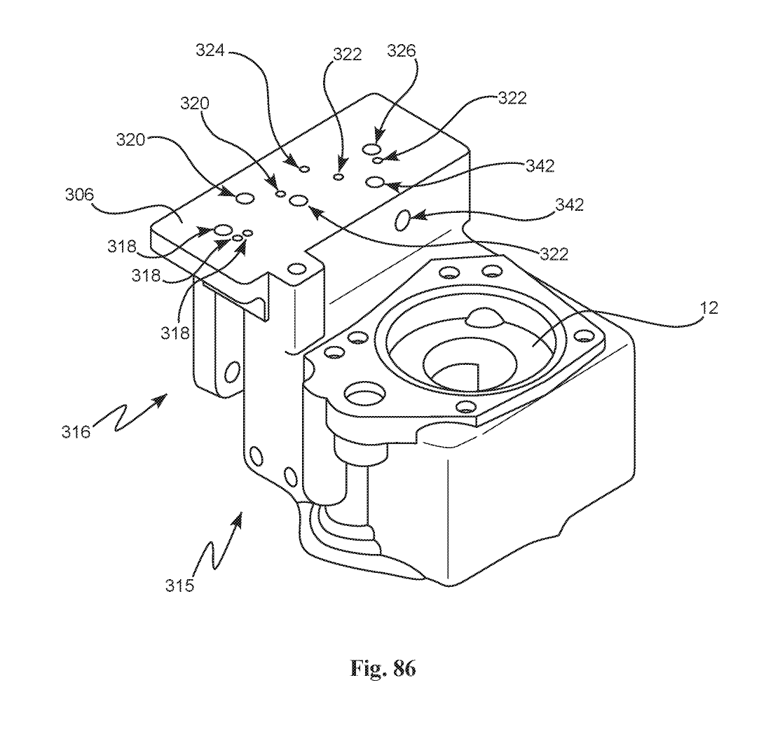

Referring to FIGS. 86-90, a modified service portion 315 of a rail control valve is compatible with the control valve system 300, when installed. The modified service portion 315 includes a body defining a piston passageway 12 and a service accelerated release valve passageway. The modified service portion 315 further includes an inshot valve received by the inshot valve passageway of the body and a service accelerated release valve passageway. The body further includes a mounting flange 305 having a further machined mounting face 306 having ECP porting. An as-cast ECP porting is shown in FIG. 91 with a thicker mounting flange 305 than the further machined ECP porting (modified ECP porting 316) shown in FIG. 86. The modified ECP porting 316 has a thinner mounting flange 305 than the as-cast ECP porting. This is done by machining material off of the mounting face 306 such that the modified ECP porting 316 has a thinner profile (i.e., the mounting flange 305 is formed with a reduced thickness). The cover plate 308 is mounted to at least a portion of the mounting face 306 of the modified ECP porting 316.

According to one embodiment, the ECP porting 24 is modified in light of the positioning of the charging check valve assembly 304 of the control valve system 300. In this embodiment, the ECP porting 24 shown in FIG. 91 can be further machined by machining down the mounting face 306 of the ECP porting 24 (to have a thinner profile). This gives the modified ECP porting 316 a thinner profile than before (compare the ECP porting 24 of FIG. 91 to the modified ECP porting 316 of FIG. 86). For instance, in one embodiment, the modified ECP porting 316 profile can be approximately 60-80% of (20-40% thinner than) the ECP porting 24. For instance, in one embodiment, 0.165 inches can be machined from the mounting face 306.

Referring to FIG. 86, the modified ECP porting 316 can include ports in the mounting face 306 of the modified ECP porting 316. The modified ECP porting 316 can include a plurality of unplugged brake cylinder exhaust ports 318. In the embodiment shown in FIG. 86, three unplugged brake cylinder exhaust ports 318 are provided. A ring gasket (not shown in FIG. 86) can surround the unplugged brake cylinder exhaust ports 318. A cover plate (not shown in FIG. 86) can cover the unplugged brake cylinder exhaust ports 318. The modified ECP porting 316 can also include a plurality of auxiliary reservoir ports 320. These auxiliary reservoir ports 320 are plugged in this embodiment, and three plugged auxiliary reservoir ports 320 are shown in FIG. 86. The modified ECP porting 316 can also include plugged brake cylinder ports 322. In the embodiment shown in FIG. 86, three plugged brake cylinder ports 322 are provided. The modified ECP

porting 316 can also include a brake pipe port 324. In the embodiment show in FIG. 86, one brake pipe port 324 is provided, and the brake pipe port 324 is plugged. The modified ECP porting 316 can also include an ECP exhaust port 326. In the embodiment show in FIG. 86, one ECP exhaust port 326 is provided, and the ECP exhaust port 326 is plugged. In one embodiment, other hole locations 342 can be plugged using ball plugs.

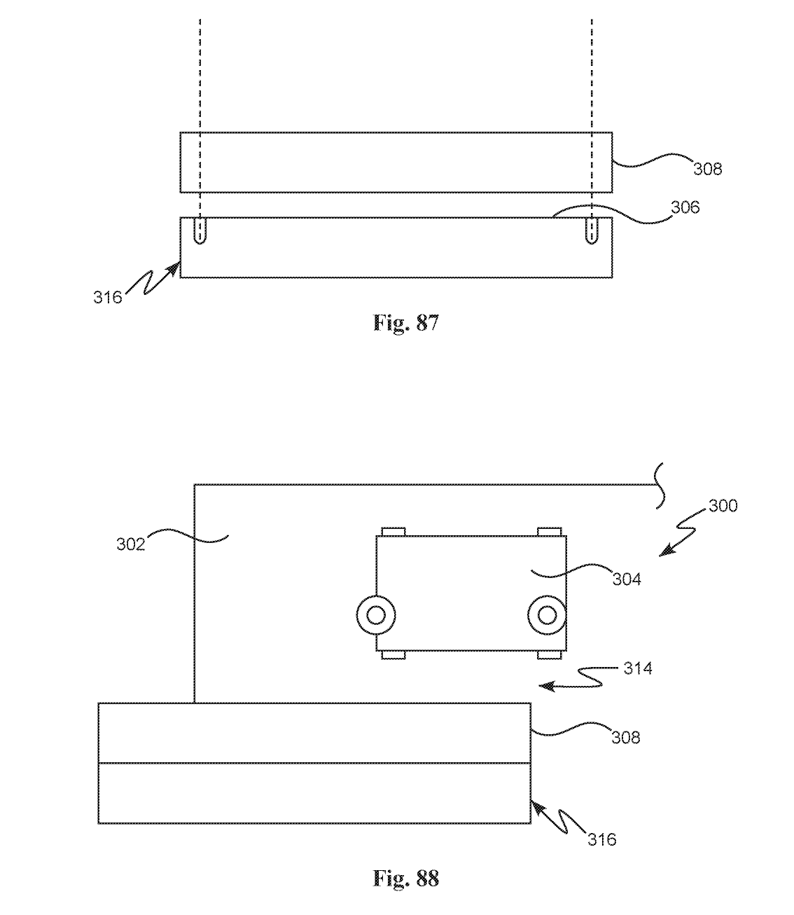

Referring to FIGS. 87-88, in one embodiment, the modified service portion 315 includes a cover plate 308 mounted to the mounting face 306 of the modified ECP porting 316. In this embodiment, the cover plate 308 is of a uniform thickness. In some embodiments, the uniform thickness cover plate can be 0.5 inches thick or less. In other embodiments, the uniform thickness cover plate 308 can be even thinner, such as 0.25 inches thick, such as 0.2 inches thick, such as 0.15 inches thick, such as 0.1 inches thick or less. As shown in FIG. 87, the uniform thickness cover plate 308 is aligned with the mounting face 306 of the modified ECP porting 316 and then mounted as shown in FIG. 88. Both the previously described machining of the ECP porting 24 to make the modified ECP porting 316 and the cover plate 308 having the above-described thickness result in a modified ECP porting 316 that is compatible with the control valve system 300, for example, a clearance 314 is formed such that the charging check valve assembly 304 and the modified ECP porting 316 having a cover plate mounted thereon do not interfere with one another. As shown in FIG. 88, the clearance 314 is present between the installed modified ECP porting 316 including a cover plate 308 and the charging check valve assembly 304. In some embodiments, the clearance 314 between the top of installed service portion 315 and the charging check valve assembly 304 is less than one inch. In other embodiments, the clearance 314 is greater than one inch, and the clearance can be any suitable distance between the installed modified service

portion 315 and the charging check valve assembly 304, based on the design of the modified service portion 315 and the control valve system 300.

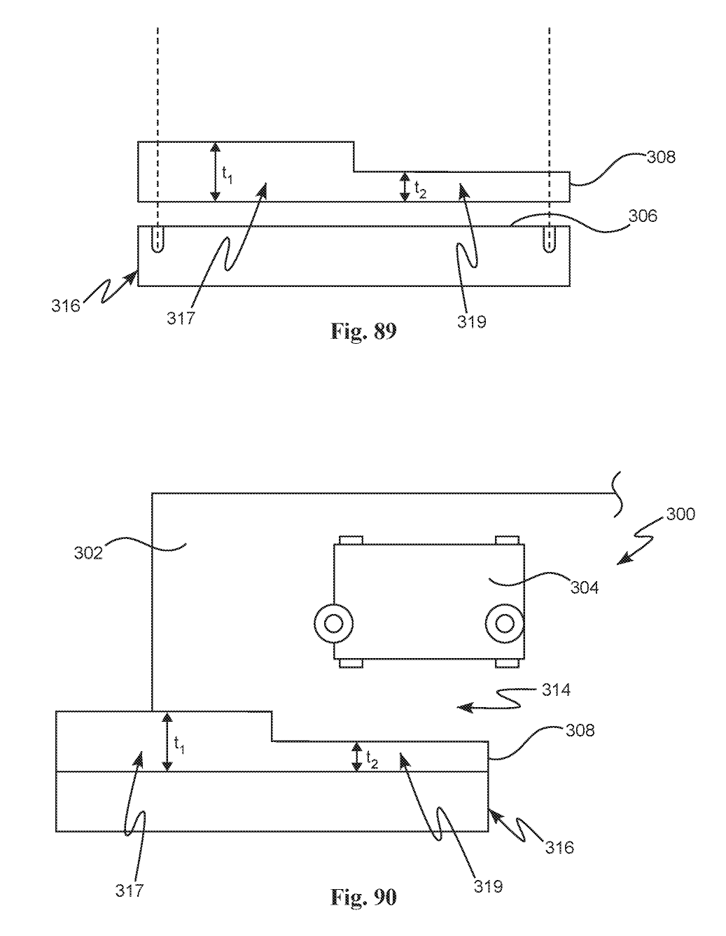

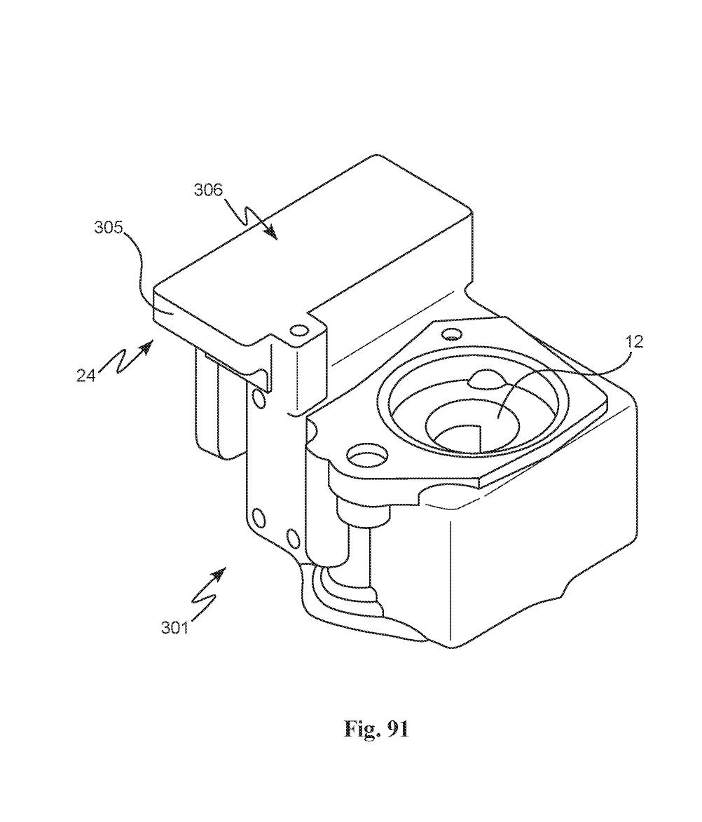

In another embodiment shown in FIGS. 89-90, the modified service portion 315 includes a cover plate 308 mounted to the mounting face 306 of the modified ECP porting 316. In this embodiment, the cover plate 308 is not of a uniform thickness, but is profiled. For example, the cover plate has a first section 317 of a first thickness t₁ and a second portion of a second thickness t₂. In this embodiment, the first thickness t₁ is greater than the second thickness t₂. Other embodiments in which more than two sections with more than two thicknesses of a profiled cover plate 308 are contemplated. In the embodiment of the profiled cover plate 308 having two sections of different thickness, the second section 319 has a second thickness t₁ of 0.5 inches thick or less. In other embodiments, the second thickness t₂ of the profiled cover plate 308 can be even thinner, such as 0.25 inches thick, such as 0.2 inches thick, such as 0.15 inches thick, such as 0.1 inches thick or less. As shown in FIG. 89, the profiled cover plate 308 is aligned with the mounting face 306 of the modified ECP porting 316 and then mounted as shown in FIG. 90. Both the previously described machining of the ECP porting 24 to make the modified ECP porting 316 and the profiled cover plate 308 having the above-described thickness result in a modified ECP porting 316 that is compatible with the control valve system 300, for example, the charging check valve assembly 304 and the top of the cover plate 308 do not interfere with one another. As shown in FIG. 90, a clearance 314 is present between the installed modified ECP porting 316 and the charging check valve assembly 304. In some embodiments, the clearance 314 between the top of the installed modified service portion 315 and the charging check valve assembly 304 is less than one inch. In other embodiments, the clearance 314 is greater than one inch, and the clearance can be any suitable distance between the top of the installed modified service portion 315 and the charging check valve assembly 304, based on the design of the modified service portion 315 and the control valve system 300. In this embodiment, when the modified service portion 315 is installed in the control valve system 300 including a charging check valve assembly 304, the second section 319 of the profiled cover plate 308 is located directly beneath the charging check valve assembly 304, and the first section 317 of the profiled cover plate 308 is not located directly beneath the charging check valve assembly 304 (see FIG. 90).

A method of making a service portion 301 of a rail control valve having a charging check valve assembly 304 is provided. The method includes providing a service portion having an ECP porting 24 having a mounting flange 305 with a mounting face 306. A plurality of ports 330 may be drilled into the mounting face 306, the ports required to connect a brake cylinder exhaust core at the mounting face 306. Mounting of the service portion 316 including the ECP porting 315 to the rail control valve is performed, which allows access to the plurality of ports 330 to be unobstructed by the charging check valve assembly 304. Machining the mounting face 306 of the mounting flange 305 may form a clearance 314 between a cover plate 308 mounted to the mounting face 306 and the charging check valve assembly 304. The rail control valve may include a pipe bracket interface 303, and an adapter plate 310 may be mounted to the pipe bracket interface 303 to raise the charging check valve assembly 304 to a further elevated position above a cover plate 308 mounted to the mounting face 306 to form a clearance 314. The plurality of ports 330 may be located adjacent to the charging check valve assembly 304 so as to be unobstructed by the charging check valve assembly 304. The method may include drilling a plurality of holes into the mounting face 306 to mount the cover plate 308 to the mounting face 306. The cover plate 308 may be mounted to at least a portion of the mounting face, and the cover plate 308 may cover less than the entire mounting face 306. The cover plate 308 may cover the plurality of ports 330.

A method is provided to render the service portion 301 compatible with the control valve system 300. In one embodiment of the method, a service portion 301 is provided, which includes an ECP porting 24 having a mounting face 306. The ECP porting 24 is further machined such that the modified (further machined) ECP porting 316 has a thinner profile than the ECP porting 24. Further machined means altering the as-cast part, such as by drilling holes into otherwise removing material from the as-cast part (such as machining down to make thinner). A cover plate 308 is mounted to the mounting face 306 of the modified service portion 315, and the cover plate 308 can have a uniform thickness or a non-uniform (such as a profiled) thickness. When installed in the control valve system 300, the modified service portion 315, which includes a modified ECP porting, includes a clearance 314 between the modified service portion 315 and the charging check valve assembly 304 of the control valve system 300.

Referring to FIGS. 91-94, a modified service portion 315 of a rail control valve is compatible with the control valve system 300, when installed. FIG. 91 shows an as-cast service portion 301 including capability for ECP porting 24, the as-cast service portion 301 not having any holes or ports drilled into the mounting face 306.

In one embodiment, an as-cast service portion 301 shown in FIG. 91 is provided, which is not initially compatible with the control valve system 300 having a charging check valve assembly 304. After modification, the modified service portion 315 is compatible with the charging check valve assembly 304, for example, the charging check valve assembly 304 and the modified service portion 315 do not interfere with one another. The ECP porting 24 of the service portion can be further machined such that the thickness of the modified ECP porting 316 has a thinner profile than the ECP porting 24 (thinner mounting flange 305). A cover plate 308 may be mounted to at least a portion of the mounting face 306. With the thickness of the mounting flange 305 reduced, a clearance 314 is present between the cover plate 308 and the charging check valve assembly 304. As previously mentioned, the modified ECP porting 316 in this embodiment includes a mounting flange 305 formed with a reduced thickness to form the clearance 314. This clearance 314 is formed by machining the mounting face 306 of the mounting flange 305. The modified ECP porting 316 can have a desired thickness 336 between an auxiliary reservoir core 338 and the mounting face 306 of the modified ECP porting 316 (see FIG. 94). The desired thickness 336 between the auxiliary reservoir core 338 and the mounting face 306 can be 0.25 inches or more.

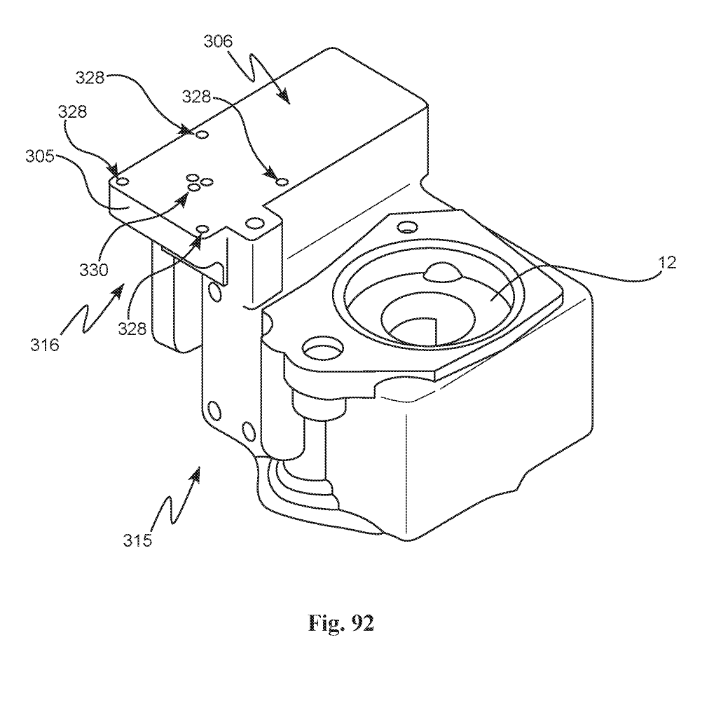

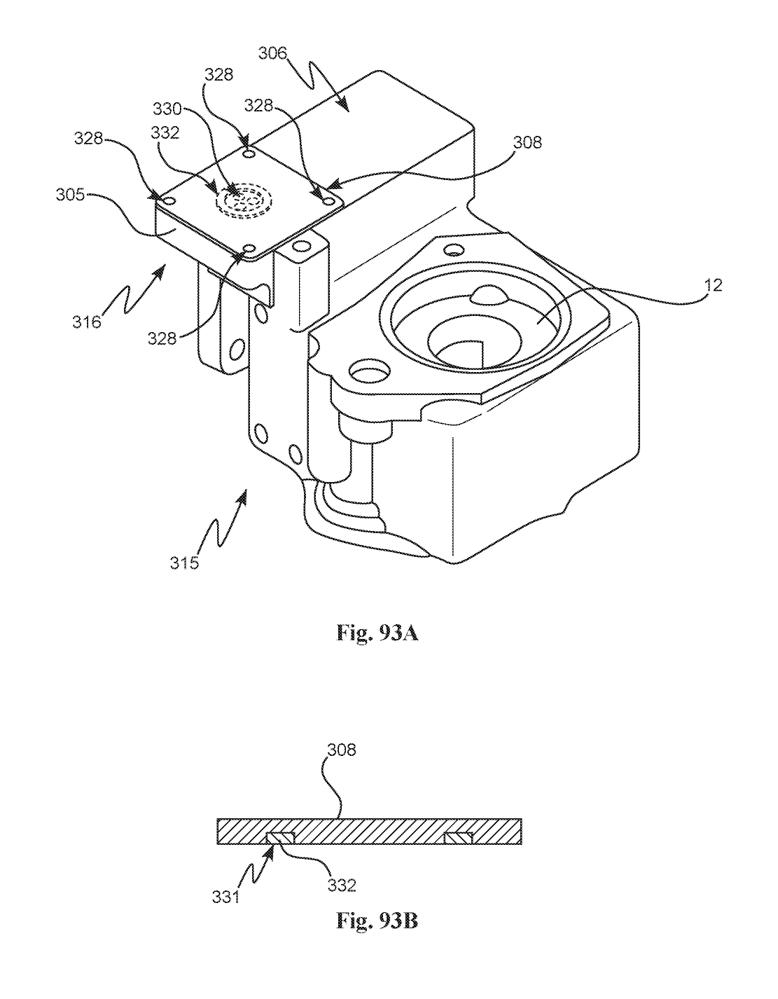

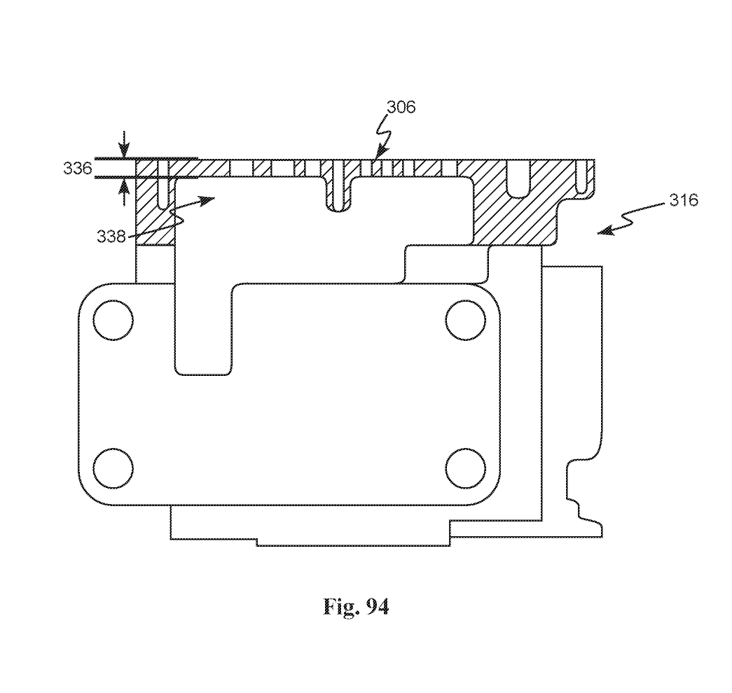

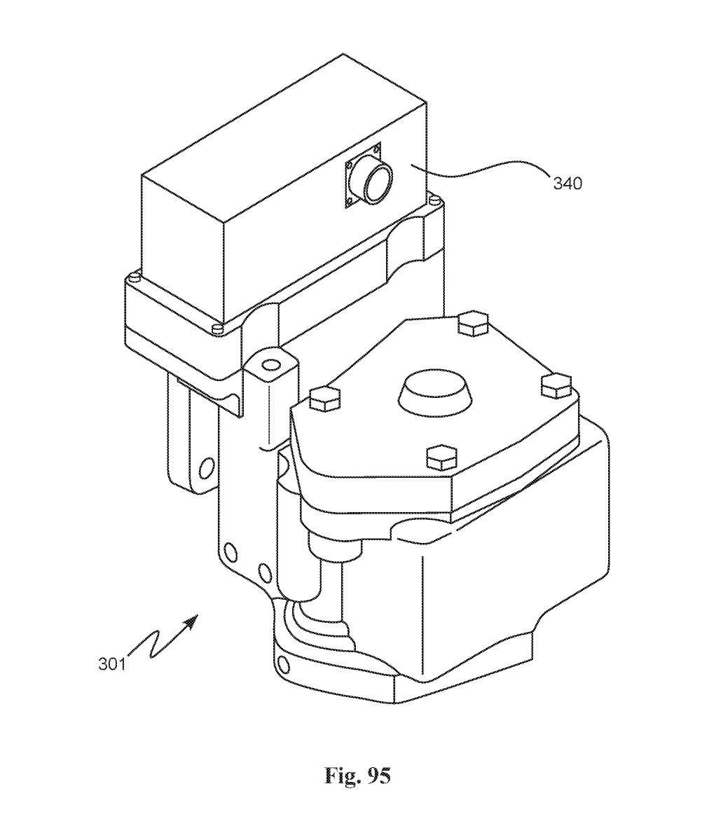

In one embodiment, the service portion 301 is machined in a different manner so as to be compatible with the control valve system 300. The mounting face 306, which includes no holes or ports in the as-cast configuration of FIG. 91, can be machined to include the required holes or ports, see FIG. 92, for instance. In this embodiment, four drilled mounting holes 328 (a plurality of holes) are drilled into the mounting face 306 of the modified ECP porting 316, which are configured to mount the cover plate 308 to the mounting face 306. In the example shown in FIG. 92, four drilled mounting holes 328 are shown. Further, a plurality of ports 330 are drilled into the mounting face of the modified ECP porting 316 that are configured to connect the brake cylinder exhaust core at the mounting face 306. In the example shown in FIG. 92, three ports are shown in the plurality of ports 330. The plurality of ports 330 configured to connect the brake cylinder exhaust core at the mounting face 306 and the plurality of drilled mounting holes 328 may be the only ports or holes drilled into the mounting face 306 (i.e., only ports or holes drilled into the mounting face 306 are mounting holes 328 to mount the cover plate 308 or ports 330 for connecting the brake cylinder exhaust core at the mounting face 306). The cover plate 308 mounted to the mounting face 306 may cover the plurality of ports 330. In a further embodiment, shown in FIG. 93A, a ring gasket 332 is provided, and the ring gasket 332 surrounds the plurality of ports 330. The ring gasket 332 can be made of any suitable material, and in one embodiment, the ring gasket 332 is made of rubber. The ring gasket 332 can fit into a recess 331 in an underside of the cover plate 308, the recess 331 shown in FIG. 93B. The recess may be an annular recess so as to allow the ring gasket 332 be be seated in the recess.

In one embodiment, the cover plate 308 mounted using the drilled mounting holes 328 in the mounting face 306 is sized to cover less than the entire mounting face 306 (see FIG. 93). In some embodiments, the cover plate 308 is sized to cover three-fourths or less of the entire mounting face 306, such as one-half or less, such as one-quarter or less. In one embodiment, the cover

plate 308 is sized to cover one-third or less of the entire mounting face 306. The cover plate 308 can cover the plurality of ports 330. Thus, in certain embodiments, the plurality of ports 330 are located over less than the entire surface of the mounting face 306. In one example, the plurality of ports 330 are all located in a section of the mounting face 306 that covers only one-third of the mounting face 306.

When installed in the control valve system 300, the modified service portion 315 according to this embodiment is compatible with the control valve system 300 and does not interfere with the charging check valve assembly 304. The charging check valve assembly 304 can be located directly above a portion of the mounting face 306 of the installed modified service portion 315 which is not covered by the cover plate 308. In this embodiment, the described arrangement prevents the cover plate 308 from interfering with the charging check valve assembly 304.

The above-described modified service portion 315 can be made according to the following method. An as-cast ECP porting 24 including a mounting face 306, for instance, as shown in

FIG. 91, can be provided. In one embodiment, the ECP porting 24 can be further machined until the modified (further machined) ECP porting 316 has a desired thickness. The desired thickness may leave at least 0.25 inches between an auxiliary reservoir core 338 and the mounting face 306. The further machined ECP porting 316 may have a thinner profile than the as-cast ECP porting 24. The as-cast ECP porting 24 can have no holes or ports in the mounting face. A plurality of ports 330 can be drilled into the mounting face 306 required to connect a brake cylinder exhaust core at the mounting face 306. A plurality of drilled mounting holes 328 can be drilled required to mount a cover plate 308 to the mounting face 306. The cover plate 308 can be mounted so as to cover at least a portion of the mounting face 306, including the plurality of ports 330. The plurality of ports 330 and drilled mounting holes 328 may be the only ports or holes drilled into the mounting face. In some embodiments, the cover plate 308 is sized to cover three-fourths or less of the entire mounting face 306, such as one-half or less, such as one-quarter or less. In one embodiment, the cover plate 308 is sized to cover one-third or less of the entire mounting face 306. The cover plate 308 may have a uniform thickness, which is 0.5 inches or less. The cover plate 308 may have a first section 317 of a first thickness t₁ and a second section 319 of a second thickness t₂, with the first thickness t₁ being greater than the second thickness t₂. The second thickness t₂ may be 0.5 inches or less. When the modified service portion 315 is installed in the control valve system 300 including a charging check valve assembly 304, the second section 319 of the profiled cover plate 308 is located directly beneath the charging check valve assembly 304, and the first section 317 of the profiled cover plate 308 is not located directly beneath the charging check valve assembly 304 (see FIG. 90).

The above-described modified service portion 315 can be installed according to the following method. A modified service portion 315 can be made, which is compatible with the control valve system 300. The modified service portion 315 can be made by providing an as-cast ECP porting 24 including a mounting face 306, for instance, as shown in FIG. 91. In one embodiment, the ECP porting 24 can be further machined until the modified (further machined) ECP porting 316 has a desired thickness. The desired thickness may leave at least 0.25 inches between the auxiliary reservoir core 338 and the mounting face 306. The as-cast ECP porting 24 can have no holes or ports in the mounting face 306. A plurality of ports 330 can be drilled into the mounting face 306 required to connect a brake cylinder exhaust core at the mounting face 306. The ring gasket 332 may surround a plurality of ports 330, and the underside of the cover plate 308 may include a recess 331 into which the ring gasket 332 is configured to fit. A plurality of drilled mounting holes 328 can be drilled, which are configured to mount a cover plate 308 to the mounting face 306. The cover plate 308 may be mounted to less than the entire mounting face 306. In some embodiments, the cover plate 308 is sized to cover three-fourths or less of the entire mounting face 306, such as one-half or less, such as one-quarter or less. In one embodiment, the cover

plate 308 is sized to cover one-third or less of the entire mounting face 306. The cover plate 308 can be sized so as to cover at least a portion of the mounting face 306. The modified service portion 315 can be installed into the control valve system 300 (including the pipe bracket 302 and the charging check valve assembly 304) so that a clearance 314 exists between the modified service portion 315 and the charging check valve assembly 304. Referring to FIGS. 69-85, an adapter plate 310 is mounted to a pipe bracket interface 303 so that a service portion 301 is compatible with a control valve system 300, for example, such that the service portion 301 and the charging check valve assembly 304 do not interfere with one another.

The service portion 301 may be installed in a control valve system 300 of a rail car including the following method steps. An adapter plate 310 as previously described may be provided. One end of the adapter plate 310 may be mounted to the pipe bracket interface 303. Another end of the adapter plate 310 may be mounted to the charging check valve assembly 304 such that the adapter plate 310 raises the charging check valve assembly 304 so as to provide the clearance 314 between the charging check valve assembly 304 and the cover plate 308 mounted to the mounting face 306 of the ECP porting 24.

Referring to FIG. 95, a service portion 301 (an ABDX-C service portion) is shown with an ECP module 340 mounted to the ECP mounting face. The ECP module 340 cannot be assembled to either a current ABDX-C service portion or to any of the embodiments described above for the modified service portion. In other words, retrofitting the service portion 301, as described above, alone does not allow the ECP module 340 to be mounted. The charging check valve assembly 304 of the Chinese AK120 pipe bracket 302 prevents this potential mounting sequence from occurring.

Service Graduating Valve and Slide Valve Design

In addition, the railroad control valve may be modified to be compatible with certain configurations, such as those used in Australia and New Zealand. The internal parts of the service portion (such as the service graduating valve and the service slide valve) compatible for use in the ABDX-C service portion used in China are not typically compatible with the specifications of the Australian and New Zealand markets. The internal parts of the service portion compatible for use in the Chinese market are shown and described in United States Patent Application Publication No. 2015/0145323, entitled “ABDX-C Service Graduating Valve and Slide Valve and Slide Valve Design Incorporating Accelerated Application Valve (AAV) Functionality”, which is incorporated herein by reference in its entirety. The design changes and modifications to the internal components to make the ABDX-C service portion compatible to the Australian and New Zealand markets are described below (the ABDX-C-AU/NZ service portion).

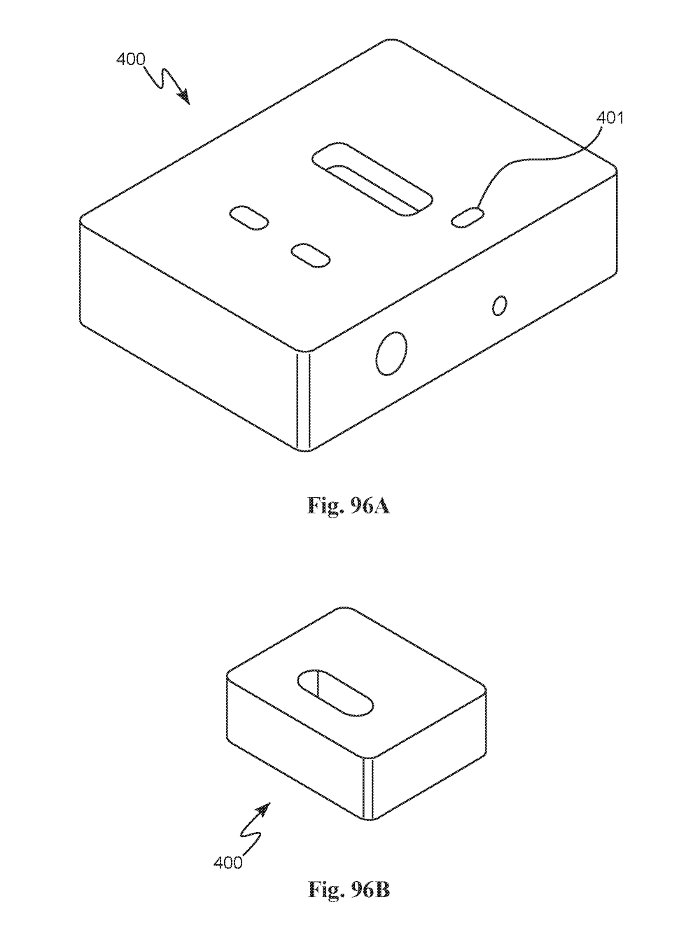

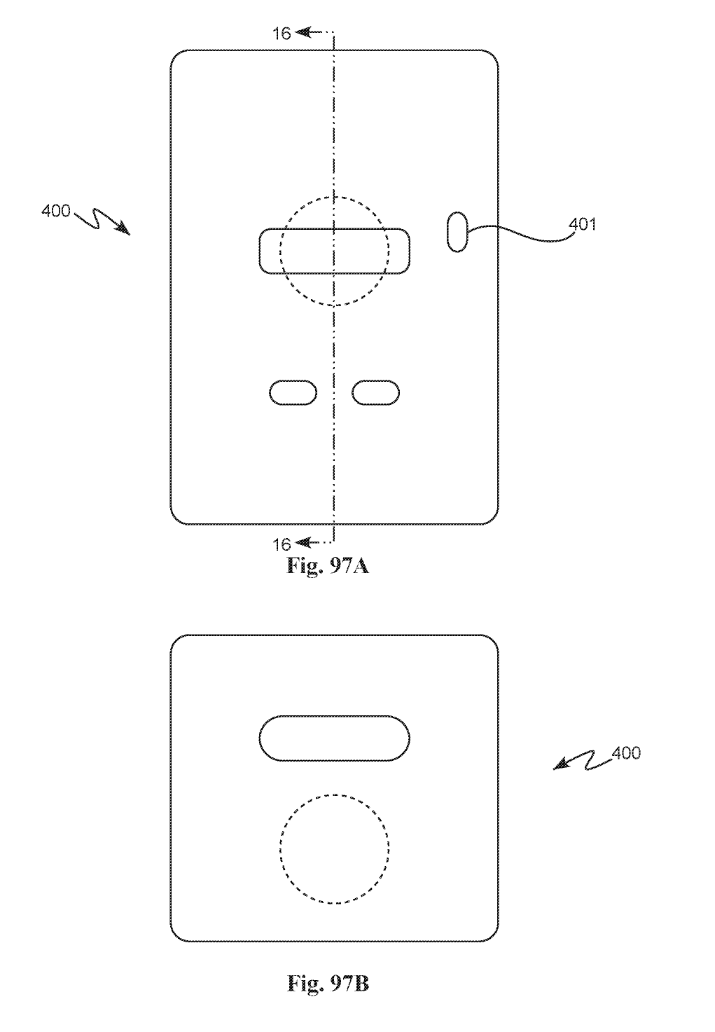

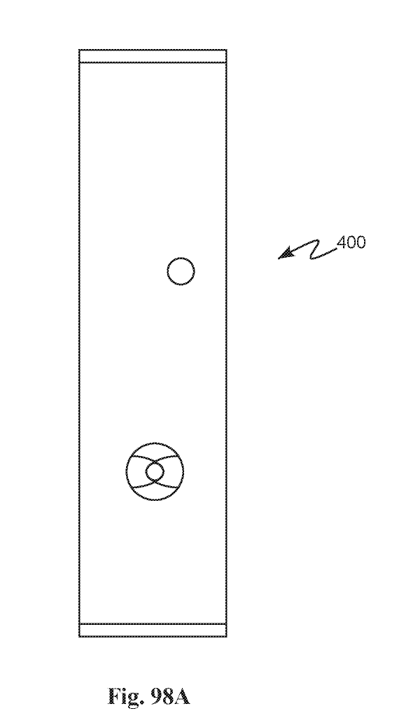

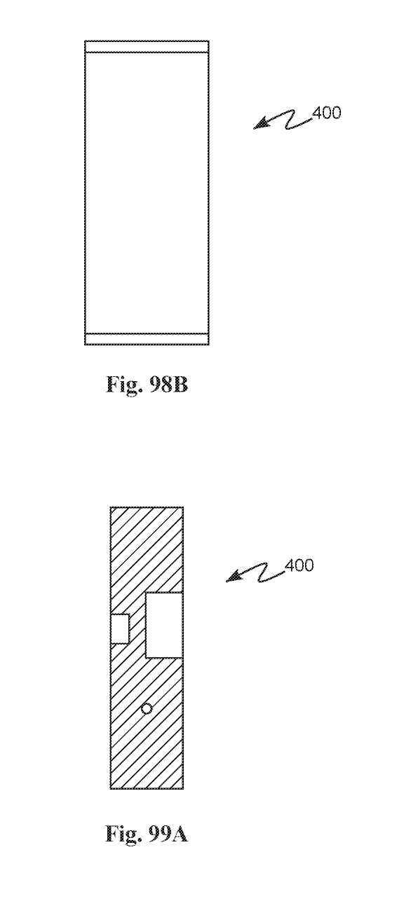

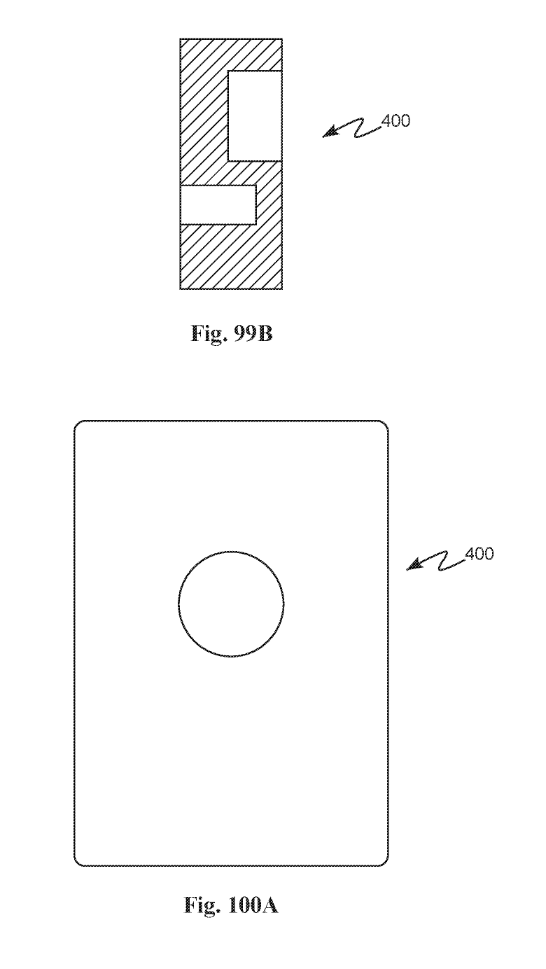

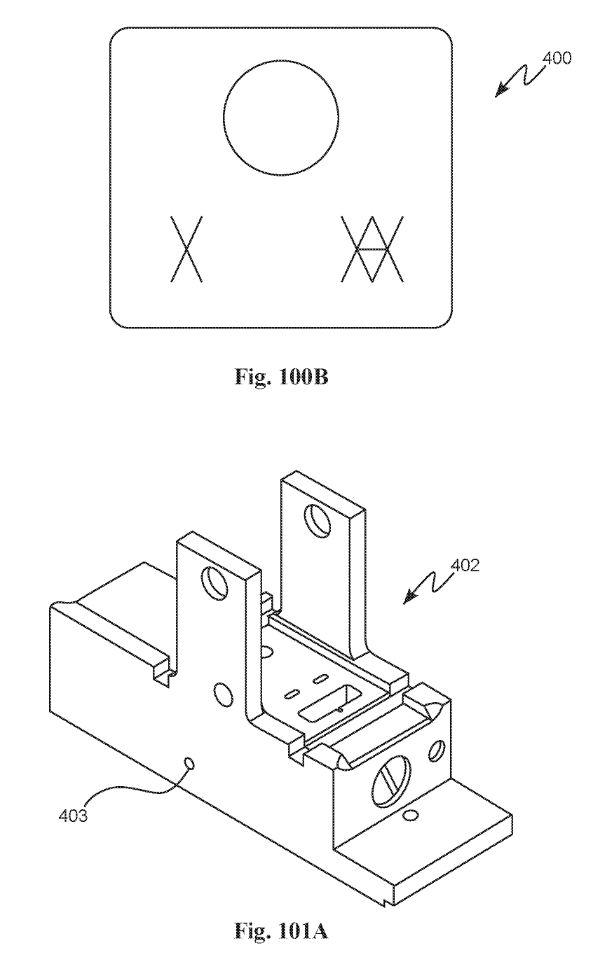

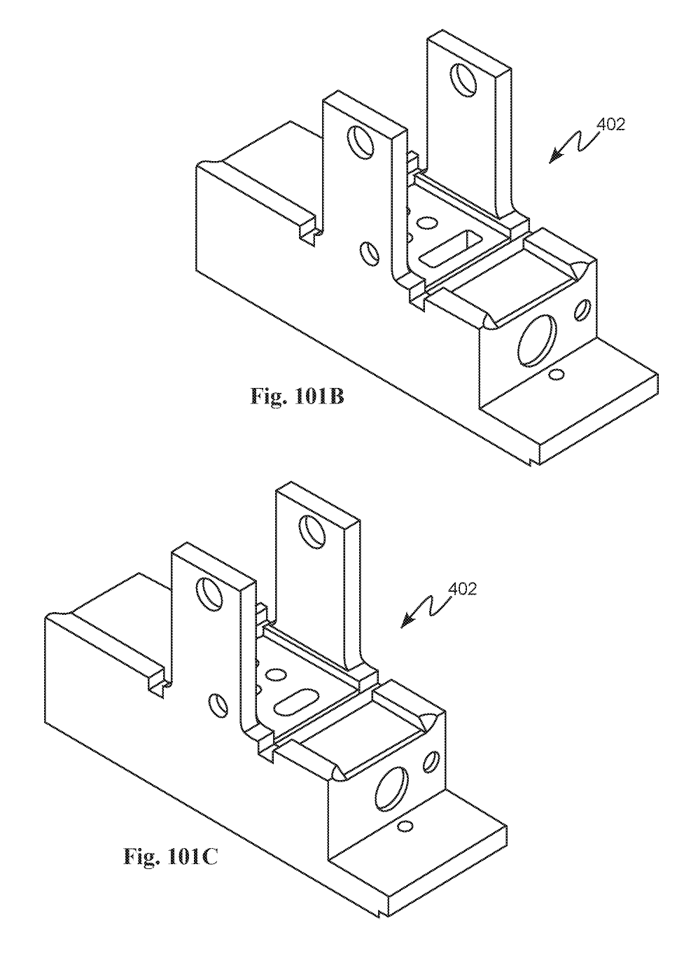

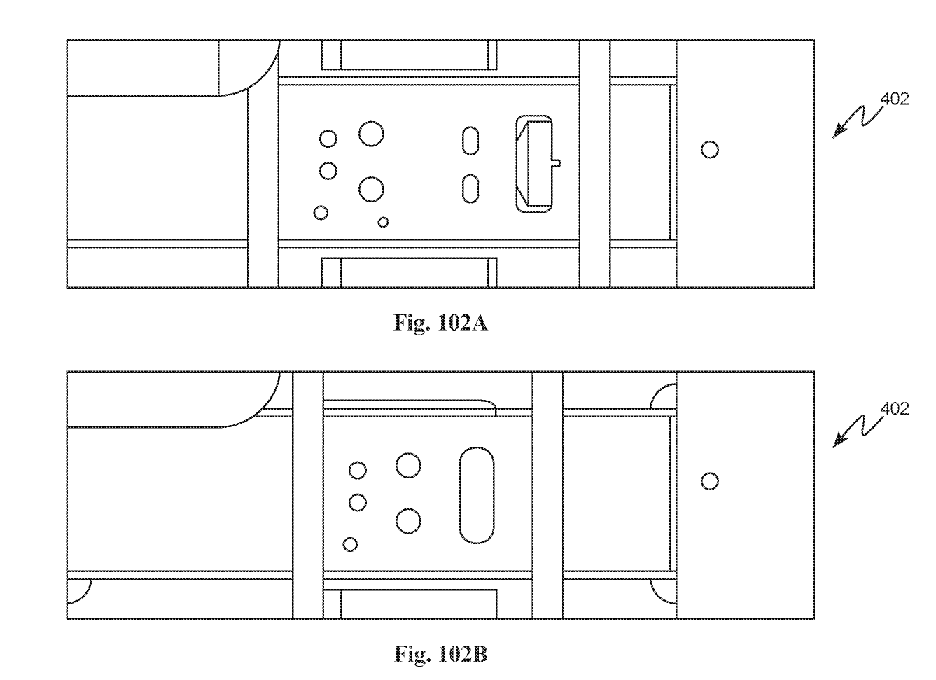

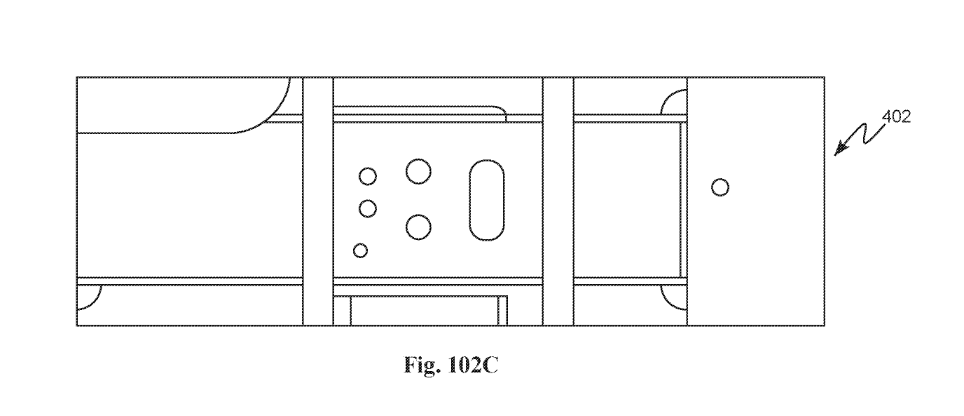

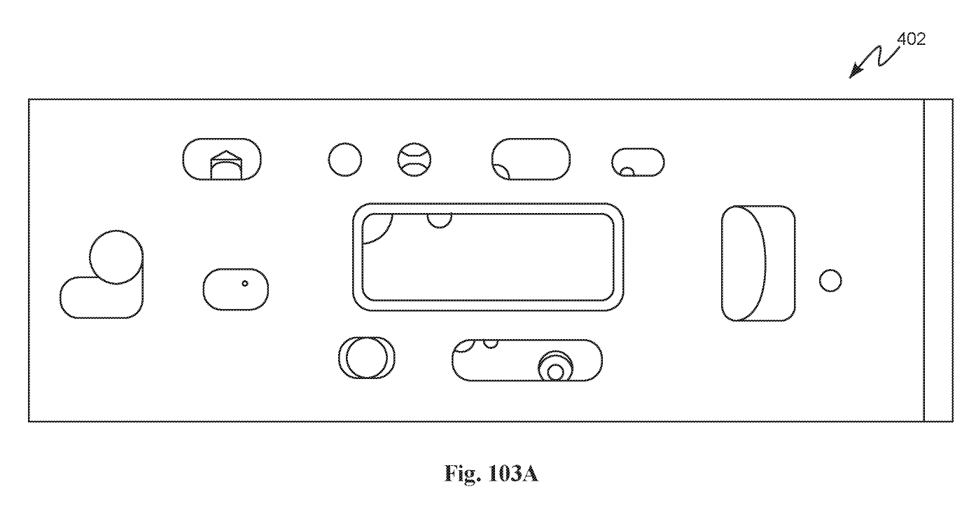

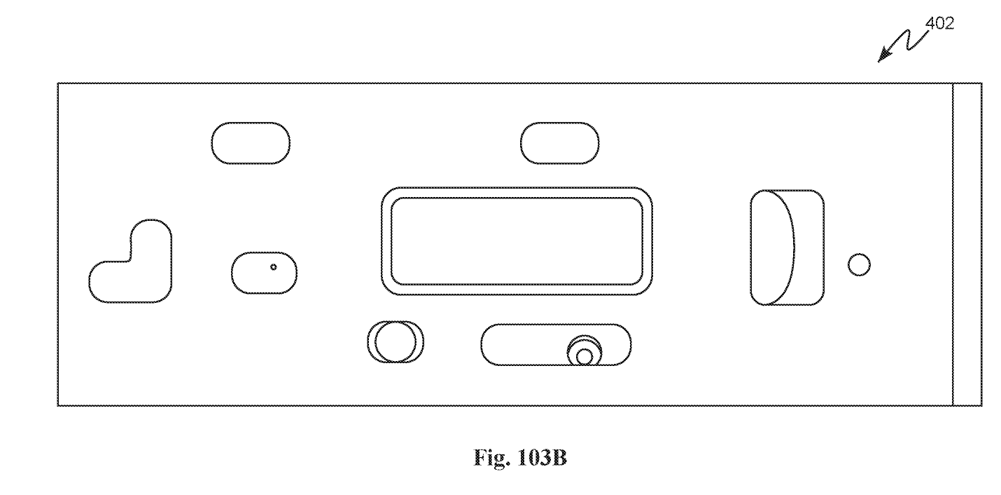

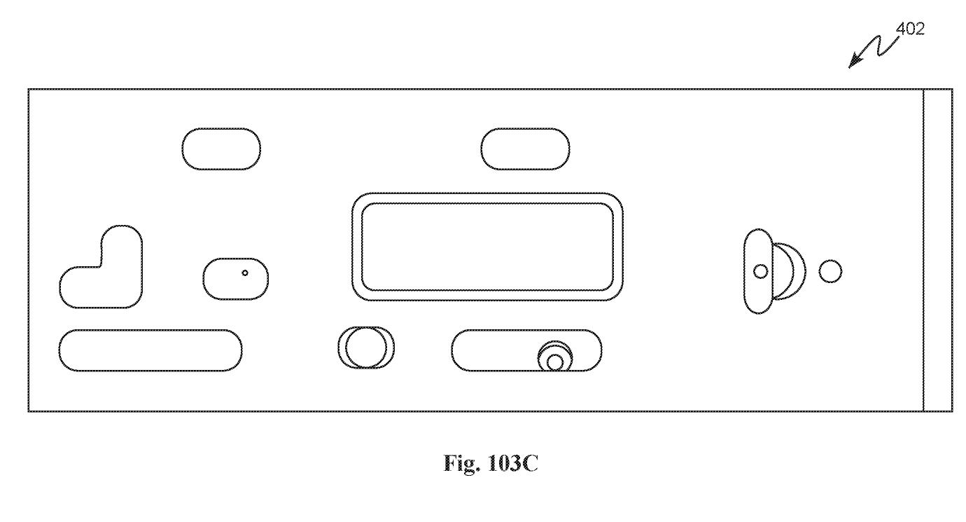

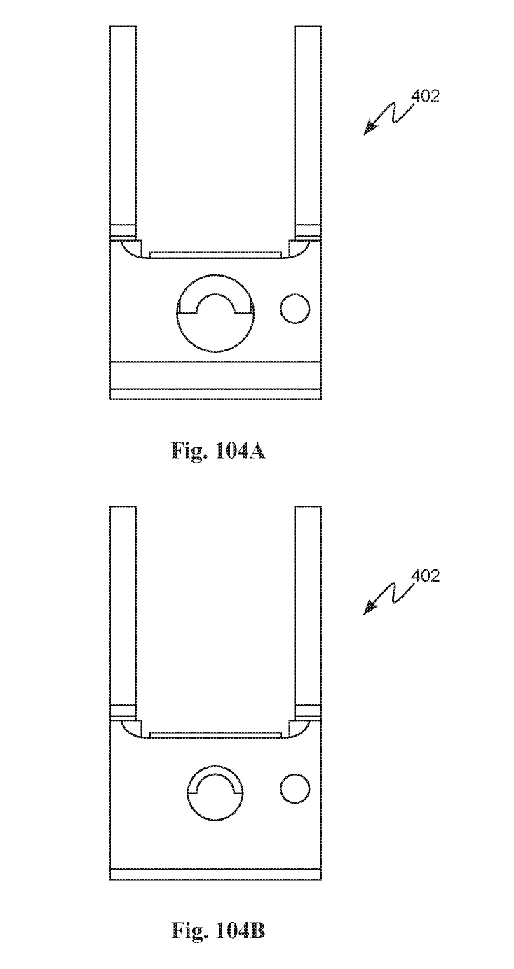

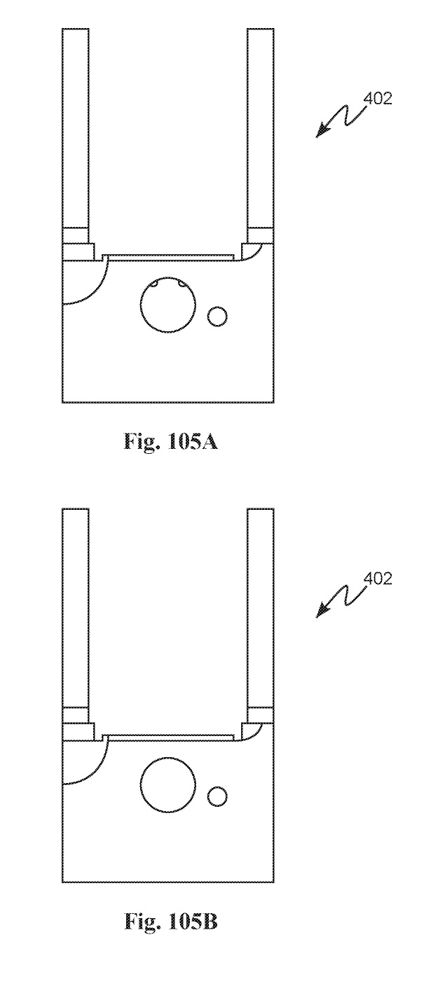

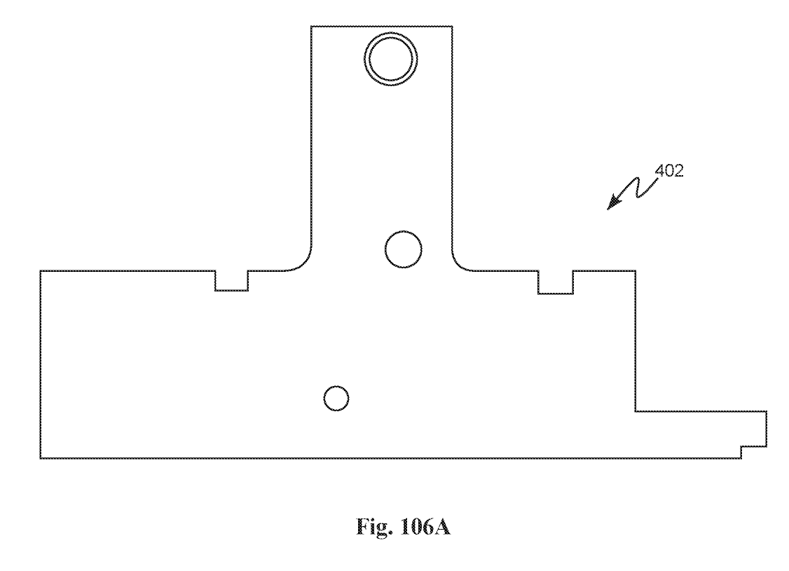

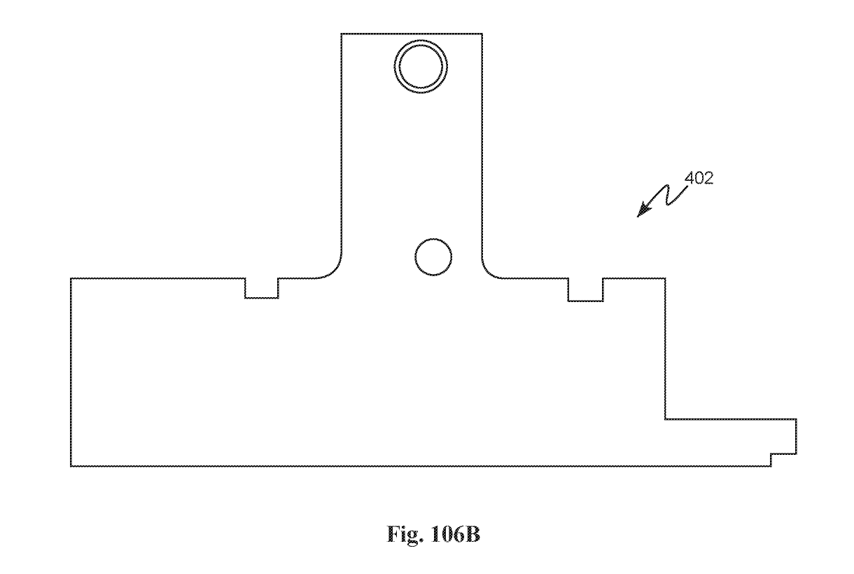

The porting between the graduating valve face, the graduating valve seat, and the slide valve face between the ABDX-C service portion and the ABDX-C-AU/NZ service portion are different as illustrated in FIGS. 96A-107.

Referring to FIG. 96A-100B, the ABDX-C service portion and the ABDX-C-AU/NZ service portion have differently designed service graduating valves 400. One embodiment of the

ABDX-C service graduating valve 400 is shown in FIGS. 96A-100A. Meanwhile, one embodiment of the modified ABDX-C-AU/NZ service portion service graduating valve 400 design is shown in
FIGS. 96B-100B. In the ABDX-C-AU/NZ service portion, the service graduating valve 400 is a standard ABDX graduating valve. In one embodiment, the service graduating valve 400 can be made from brass. In another embodiment, the service graduating valve 400 can be made from stainless steel. In the ABDX-C service portion a porting pattern on the bottom side of the service graduating valve 400 also includes an accelerated release reservoir to auxiliary reservoir bleeder port 401, which, during a slight brake pipe over-reduction condition, allows pressure from the higher pressure accelerated release reservoir to flow into the auxiliary reservoir pressure while a service slide valve 402 (not shown) remains in the full service position in order to move the service graduating valve 400 to its full service position on a graduating valve seat and, therefore, ensure positive shut down of the AAV function. In contrast, the ABDX-C-AU/NZ grad valve typically has no bleeder port 401 or AAV functionality. In one embodiment of the ABDX-C service portion, the graduating valve seat and the slide valve face each includes an accelerated release reservoir port in order to provide pressure from the accelerated release reservoir to the graduating valve face to ensure positive AAV shutdown. In the ABDX-C-AU/NZ service portion, the graduating valve seat does not contain the extra accelerated release reservoir port to graduating valve face. The graduating valve face used is the standard ABDX graduating valve.

Referring to FIGS. 101A-106B, the ABDX-C service portion and the ABDX-C-AU/NZ service portion have differently designed service slide valves 402. One embodiment of the ABDX-C service portion service slide valve 402 is shown in FIGS. 101A-106A. Meanwhile, one embodiment of the modified ABDX-AU service slide valve 402 is shown in FIGS. 101B-106B. Furthermore, one embodiment of the modified ABDX-C-NZ service slide valve 402 is shown in FIGS. 101C-103C and FIGS. 104B-106B. The service slide valve 402 used in both the ABDX-C-AU and ABDX-C-NZ service portions contains all of the same port sizes as a standard ABDX except for the brake cylinder feed port. Referring to FIG. 101A, 101B, and 101C the ABDX-C service portion includes a port 403 on the side of the service slide valve 402 (see FIG. 101A). In both the ABDX-C-AU and ABDX-C-NZ service portions, this port 403 does not exist (see FIGS. 101B and 101C showing no port 403) since a boost feature is not required in either Australia or New Zealand. Both the ABDX-C-AU/NZ portions are not required to contain AAV function. Therefore, the slide valves and grad valve designs were modified to eliminate this specific function.

In one embodiment, a lug hole in the pipe bracket gasket face was plugged, a new lug hole was drilled into a location on the pipe bracket gasket face to match the location present in the AK120 service portion face.

In one embodiment of the ABDX-C-AU service portion, the auxiliary reservoir charging choke was replaced with an auxiliary reservoir charging choke to fit Australian specifications. Likewise, in another embodiment of the ABDX-C-NZ service portion, the auxiliary reservoir charging choke was replaced with an auxiliary reservoir charging choke to fit New Zealand specifications.

In one embodiment, the service bottom covers of the ABDX-C service portion were modified for use with either the ABDX-C-AU or ABDX-C-NZ service portions. The service bottom covers were tapped to contain a threaded portion. The brake cylinder exhaust choke of the ABDX-C service portion was removed, and a modified brake cylinder exhaust choke was threaded inside the modified service bottom cover, such that the brake cylinder exhaust time complies with Australian single car test standard as per RISSB AN214 Section 3.3.1 and 12.4.3 and KiwiRail single car test standard in New Zealand. An external wasp excluder vent protector assembly was threaded directly into each modified service bottom cover in the brake cylinder exhaust port.

The auxiliary reservoir fill choke located beneath the auxiliary reservoir diaphragm check valve on the ECP coin plate mounting face was removed and replaced with a plug in the ABDX-C-AU and ABDX-C-NZ service portions. This modification is advantageous because it prevents any possible leak of brake cylinder to brake cylinder exhaust in the valve portion if the ECP auxiliary reservoir fill diaphragm leaks.

The brake cylinder exhaust choke located beneath the ECP brake cylinder exhaust diaphragm was removed and replaced with a plug in the ABDX-C-AU and ABDX-C-NZ service portions. This modification is advantageous because it prevents any possible leak of brake cylinder to brake cylinder exhaust in the valve portion if the ECP brake cylinder exhaust diaphragm leaks.

Specific components of both the ABDX-C-AU and ABDX-C-NZ can be thoroughly lubricated with an adequate film of transmission fluid, such as Mobil Delvac Synthetic Transmission Fluid Arctic. This may be done to prevent the lubrication from running off of the components as quickly given the hotter average temperatures in both Australia and New Zealand. Components that may be lubricated as described include, but are not limited to, plastic wear rings, main piston bores, slide valve seats, slide valve faces, graduating valves seats, and graduating valve faces.

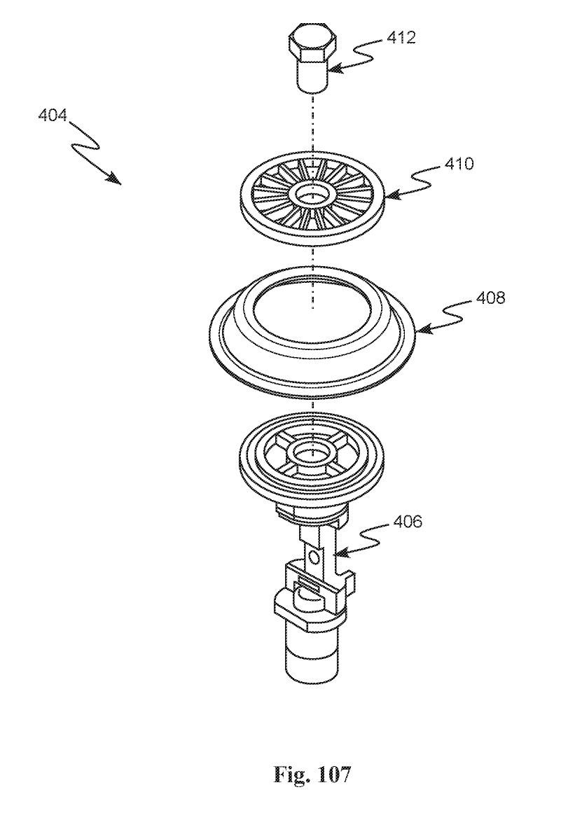

FIG. 107 shows one embodiment of a main piston assembly 404 used in the ABDX-C service portion. The main piston assembly 404 in the ABDX-C service portion comprises a piston 406, a diaphragm 408, a follower 410, and a bolt 412. Several modifications have been made to the components, for example, the piston 406 and the diaphragm 408 of the main piston assembly 404 in FIG. 107 for use with either the ABDX-C-AU or ABDX-C-NZ service portions. Specifically, the piston 406 shown in FIG. 107 is replaced with the standard ABDX service piston for use in both the ABDX-C-AU and ABDX-C-NZ service portions.

Where the ABDX-C service portion uses special rubber components, the ABDX-C-AU and ABDX-C-NZ service portions may replace these components with the standard ABDX rubber components. These rubber components can be adequately lubricated, as necessary.

The present invention further includes the subject matter of the following clauses.

Clause 1: A service portion of a rail control valve having a charging check valve assembly comprising:
a body defining a piston passageway, an inshot valve passageway, and a service accelerated release valve passageway, wherein the body comprises a mounting flange having a mounting face having ECP porting;
an inshot valve received by the inshot valve passageway;
a service accelerated release valve received by the service accelerated release valve passageway; and
a cover plate mounted to at least a portion of the mounting face,
wherein a clearance is present between the cover plate and the charging check valve assembly.

Clause 2: The service portion of clause 1, wherein the mounting flange of the ECP porting is formed with a reduced thickness to form the clearance.

Clause 3: The service portion of clause 2, wherein the clearance is formed by machining the mounting face of the mounting flange.

Clause 4: The service portion of clause 1, wherein the cover plate has a uniform thickness.

Clause 5: The service portion of clause 1, wherein the cover plate comprises a first section of a first thickness and a second section of a second thickness, wherein the first thickness is greater than the second thickness to define the clearance.

Clause 6: The service portion of clause 5, wherein the second section of the cover plate is located directly beneath the charging check valve assembly.

Clause 7: The service portion of clause 1, wherein the rail control valve comprises a pipe bracket interface, and further comprising an adapter plate mounted to the pipe bracket interface to raise the charging check valve assembly to a further elevated position above the cover plate to form the clearance.

Clause 8: The service portion of clause 7, wherein the adapter plate is L-shaped comprising a vertical leg and a horizontal leg, the vertical leg forming a connection to the pipe bracket interface.

Clause 9: A service portion of a rail control valve having a charging check valve assembly comprising:
a body defining a piston passageway, an inshot valve passageway, and a service accelerated release valve passageway, wherein the body comprises a mounting flange having a mounting face having ECP porting;
an inshot valve received by the inshot valve passageway of the body; and
a service accelerated release valve received by the service accelerated release valve passageway,
wherein the ECP porting comprises a plurality of ports in the mounting face and located adjacent to the charging check valve assembly whereby access to the plurality of ports is unobstructed by the charging check valve assembly, the plurality of ports configured to connect a brake cylinder exhaust core at the mounting face.

Clause 10: The service portion of clause 9, further comprising a cover plate mounted to at least a portion of the mounting face so as to cover the plurality of ports.

Clause 11: The service portion of clause 10, wherein the mounting face is machined so as to have a thickness between an auxiliary reservoir core and the mounting face of at least 0.25 inches.

Clause 12: The service portion of clause 10, wherein the cover plate covers less than the entire mounting face.

Clause 13: The service portion of clause 10, wherein the cover plate comprises an annular recess in a side thereof mounted to the mounting face, wherein a ring gasket is seated in the recess.

Clause 14: The service portion of clause 12, wherein the charging check valve assembly is located directly above a portion of the mounting face that is uncovered by the cover plate.

Clause 15: A method of making a service portion of a rail control valve having a charging check valve assembly comprising the steps of:
providing a service portion comprising a mounting flange having a mounting face having ECP porting;
providing a plurality of ports into the mounting face to connect a brake cylinder exhaust core at the mounting face; and
mounting the service portion including the ECP porting to the rail control valve, whereby access to the plurality of ports is unobstructed by the charging check valve assembly.

Clause 16: The method of clause 15, further comprising
machining the mounting face of the mounting flange to form a clearance between a cover plate mounted to the mounting face and the charging check valve assembly.

Clause 17: The method of clause 15, wherein the rail control valve comprises a pipe bracket interface, further comprising mounting an adapter plate to the pipe bracket interface to raise the charging check valve assembly to a further elevated position above a cover plate mounted to the mounting face to form a clearance.

Clause 18: The method of clause 15, wherein the plurality of ports are located adjacent to the charging check valve assembly.

Clause 19: The method of clause 15, further comprising
providing a plurality of holes in the mounting face to mount a cover plate to the mounting face, and
mounting the cover plate to at least a portion of the mounting face.

Clause 20: The method of clause 18, further comprising
providing a plurality of holes in the mounting face to mount a cover plate to the mounting face,
mounting the cover plate to at least a portion of the mounting face, wherein the cover plate covers less than the entire mounting face, and wherein the cover plate covers the plurality of ports.

Clause 21: The service portion of clause 4, wherein the thickness of the cover plate is 0.5 inches or less.

Clause 22: The service portion of clause 5, wherein the second thickness is 0.5 inches or less.

Clause 23: The service portion of claim 12, wherein the cover plate is mounted to one-third or less of the entire mounting face.

While several embodiments were described in the foregoing detailed description, those skilled in the art may make modifications and alterations to these embodiments without departing from the scope and spirit of the invention. Accordingly, the foregoing description is intended to be illustrative rather than restrictive.

Similarly, it will be appreciated that the various method steps identified and described above may be varied, and that the order of steps may be adapted to particular applications of the techniques disclosed herein. All such variations and modifications are intended to fall within the scope of this disclosure. As such, the description of an order for various steps should not be understood to require a particular order of execution of those steps, unless required by a particular application or explicitly stated otherwise.

The invention claimed is:

1. A service portion of a rail control valve having a charging check valve assembly comprising:
a body defining a piston passageway, an inshot valve passageway, and a service accelerated release valve passageway, wherein the body comprises a mounting flange having a mounting face having ECP porting;
an inshot valve received by the inshot valve passageway;
a service accelerated release valve received by the service accelerated release valve passageway; and
a cover plate mounted to at least a portion of the mounting face,
wherein a clearance is present between the cover plate and the charging check valve assembly.

2. The service portion of claim 1, wherein the mounting flange of the ECP porting is formed with a reduced thickness to form the clearance.

3. The service portion of claim 2, wherein the clearance is formed by machining the mounting face of the mounting flange.

4. The service portion of claim 1, wherein the cover plate has a uniform thickness.

5. The service portion of claim 1, wherein the cover plate comprises a first section of a first thickness and a second section of a second thickness, wherein the first thickness is greater than the second thickness to define the clearance.

6. The service portion of claim 5, wherein the second section of the cover plate is located directly beneath the charging check valve assembly.

7. The service portion of claim 1, wherein the rail control valve comprises a pipe bracket interface, and further comprising an adapter plate mounted to the pipe bracket interface to raise the charging check valve assembly to a further elevated position above the cover plate to form the clearance.

8. The service portion of claim 7, wherein the adapter plate is L-shaped comprising a vertical leg and a horizontal leg, the vertical leg forming a connection to the pipe bracket interface.

9. A service portion of a rail control valve having a charging check valve assembly comprising:
a body defining a piston passageway, an inshot valve passageway, and a service accelerated release valve passageway, wherein the body comprises a mounting flange having a mounting face having ECP porting;
an inshot valve received by the inshot valve passageway of the body; and
a service accelerated release valve received by the service accelerated release valve passageway,
wherein the ECP porting comprises a plurality of ports in the mounting face and located adjacent to the charging check valve assembly whereby access to the plurality of ports is unobstructed by the charging check valve assembly, the plurality of ports configured to connect a brake cylinder exhaust core at the mounting face.

10. The service portion of claim 9, further comprising a cover plate mounted to at least a portion of the mounting face so as to cover the plurality of ports.

11. The service portion of claim 10, wherein the mounting face is machined so as to have a thickness between an auxiliary reservoir core and the mounting face of at least 0.25 inches.

12. The service portion of claim 10, wherein the cover plate covers less than the entire mounting face.

13. The service portion of claim 10, wherein the cover plate comprises an annular recess in a side thereof mounted to the mounting face, wherein a ring gasket is seated in the recess.

14. The service portion of claim 12, wherein the charging check valve assembly is located directly above a portion of the mounting face that is uncovered by the cover plate.

15. A method of making a service portion of a rail control valve having a charging check valve assembly comprising the steps of:
providing a service portion comprising a mounting flange having a mounting face having ECP porting;
providing a plurality of ports into the mounting face to connect a brake cylinder exhaust core at the mounting face; and
mounting the service portion including the ECP porting to the rail control valve, whereby access to the plurality of ports is unobstructed by the charging check valve assembly.

16. The method of claim 15, further comprising
machining the mounting face of the mounting flange to form a clearance between a cover plate mounted to the mounting face and the charging check valve assembly.

17. The method of claim 15, wherein the rail control valve comprises a pipe bracket interface, further comprising mounting an adapter plate to the pipe bracket interface to raise the charging check valve assembly to a further elevated position above a cover plate mounted to the mounting face to form a clearance.

18. The method of claim 15, wherein the plurality of ports are located adjacent to the charging check valve assembly.

19. The method of claim 15, further comprising providing a plurality of holes in the mounting face to mount a cover plate to the mounting face, and
mounting the cover plate to at least a portion of the mounting face.

20. The method of claim 18, further comprising
providing a plurality of holes in the mounting face to mount a cover plate to the mounting face, and
mounting the cover plate to at least a portion of the mounting face, wherein the cover plate covers less than the entire mounting face, and wherein the cover plate covers the plurality of ports.
